(19) United States
(12) Patent Application Publication
(10) Pub. No.: US 2026/0042618 A1
(43) Pub. Date: Feb. 12, 2026

(54) ROBOTIC SYSTEM WITH TRANSFERRING STRUCTURE

(71) Applicant: MUJIN, INC., Tokyo (JP)

(72) Inventors: Denys KANUNIKOV, Tokyo (JP); Floris GAISSER, Tokyo (JP); Takashi FUJIOKA, Tokyo (JP); Innocentio Aloysius LOE, Tokyo (JP); Shekhar GUPTA, Tokyo (JP)

(21) Appl. No.: 19/363,033

(22) Filed: Oct. 20, 2025

Related U.S. Application Data
(63) Continuation of application No. PCT/IB2025/055151, filed on May 16, 2025.
(60) Provisional application No. 63/648,679, filed on May 17, 2024.

(51) Int. Cl. B65G 47/90; B65G 67/20

(52) U.S. Cl. CPC B65G 47/90; B65G 67/20

(57) ABSTRACT

A robotic system including a transferring structure is provided. The robotic system is configured to receive objects or workpieces at a transferring structure where they are received by an object loader disposed on a robotic arm. The object loader is used to transfer the objects to a container. The robotic system is configured to receive multiple object and transfer the object to the container to pack the container. The robotic system is configured to determine a method of throwing or releasing each object into the container to permit greater packing efficiency.

### RELATED APPLICATIONS

This application is a continuation of International Application No. PCT/IB2025/055151, filed on May 16, 2025, which claims the priority benefit of U.S. Provisional Application No. 63/648,679, filed on May 17, 2024, the entire content of each of which are incorporated by reference herein.

### TECHNICAL FIELD

The present technology is directed generally to robotic systems and, more specifically, to systems, processes, and techniques for transferring and loading objects.

### BACKGROUND

With their ever-increasing performance and lowering cost, many robots (e.g., machines configured to automatically/autonomously execute physical actions) are now extensively used in various different fields. Robots, for example, can be used to execute various tasks (e.g., manipulate or transfer an object through space) in manufacturing and/or assembly, packing and/or packaging, transport and/or shipping, etc. In executing the tasks, the robots can perform physical actions, thereby replacing or reducing human involvements that are otherwise required to perform dangerous or repetitive tasks.

However, despite the technological advancements, robots often lack the sophistication necessary to duplicate human interactions required for executing larger and/or more complex tasks. Accordingly, there remains a need for improved techniques and systems for managing operations and/or interactions between robots.

### BRIEF DESCRIPTION OF THE DRAWINGS

FIG. 1 is an illustration of an example environment in which a robotic system with a coordinated transfer mechanism may operate.

FIG. 2 is a block diagram illustrating the robotic system in accordance with one or more embodiments of the present technology.

FIGS. 3A-3D is an illustration of a robotic object loading system according to embodiments disclosed herein.

FIGS. 4A-D illustrate an object loader according to embodiments disclosed herein.

FIGS. 5A-5C illustrate an object loader according to embodiments disclosed herein.

FIGS. 6A-6F illustrate aspects of an object transfer system according to embodiments disclosed herein.

FIG. 7 is a flowchart illustrating an object loading process according to embodiments disclosed herein.

FIGS. 8A-8K are flowcharts illustrating an object loading process according to embodiments disclosed herein.

FIG. 9 is a flowchart illustrating a throw decision process according to embodiments disclosed herein.

FIGS. 10A-10C illustrate aspects of an object loading throw according to embodiments disclosed herein.

FIGS. 11A-11C illustrate aspects of an object loading throw according to embodiments disclosed herein.

FIGS. 12A-12C illustrate aspects of an object loading throw according to embodiments disclosed herein.

FIGS. 13A-13C illustrate aspects of an object loading throw according to embodiments disclosed herein.

FIGS. 14A-14D illustrate aspects of an object loading throw according to embodiments disclosed herein.

FIGS. 15A-15B illustrate aspects of an object loading throw according to embodiments disclosed herein.

FIGS. 16A-16C illustrate aspects of an object loading throw according to embodiments disclosed herein.

### DETAILED DESCRIPTION

Systems and methods for a robotic system with a coordinated transfer mechanism are described herein. The robotic system (e.g., an integrated system of devices that each execute one or more designated tasks) configured in accordance with some embodiments autonomously executes integrated tasks by coordinating operations of multiple units (e.g., robots).

In the following, numerous specific details are set forth to provide a thorough understanding of the presently disclosed technology. In other embodiments, the techniques introduced here can be practiced without these specific details. In other instances, well-known features, such as specific functions or routines, are not described in detail to avoid unnecessarily obscuring the present disclosure. References in this description to “an embodiment,” “one embodiment,” or the like mean that a particular feature, structure, material, or characteristic being described is included in at least one embodiment of the present disclosure. Thus, the appearances of such phrases in this specification do not necessarily all refer to the same embodiment. On the other hand, such references are not necessarily mutually exclusive either. Furthermore, the particular features, structures, materials, or characteristics can be combined in any suitable manner in one or more embodiments. It is to be understood that the various embodiments shown in the figures are merely illustrative representations and are not necessarily drawn to scale.

Several details describing structures or processes that are well-known and often associated with robotic systems and subsystems, but that can unnecessarily obscure some significant aspects of the disclosed techniques, are not set forth in the following description for purposes of clarity. Moreover, although the following disclosure sets forth several embodiments of different aspects of the present technology, several other embodiments can have different configurations or different components than those described in this section. Accordingly, the disclosed techniques can have other embodiments with additional elements or without several of the elements described below.

Many embodiments or aspects of the present disclosure described below can take the form of computer- or controller-executable instructions, including routines executed by a programmable computer or controller. Those skilled in the relevant art will appreciate that the disclosed techniques can be practiced on computer or controller systems other than those shown and described below. The techniques described herein can be embodied in a special-purpose computer or data processor that is specifically programmed, configured, or constructed to execute one or more of the computer-executable instructions described below. Accordingly, the terms “computer,” “controller,” and/or “control circuit” as generally used herein refer to any data processor and can include Internet appliances and handheld devices (including palm-top computers, wearable computers, cellular or mobile phones, multi-processor systems, processor-based or programmable consumer electronics, network computers, mini computers, and the like). Information handled by these computers and controllers can be presented at any suitable display medium, including a liquid crystal display (LCD). Instructions for executing computer- or controller-executable tasks can be stored in or on any suitable computer-readable medium, including hardware, firmware, or a combination of hardware and firmware. Instructions can be contained in any suitable memory device, including, for example, a flash drive, USB device, and/or other suitable medium.

The terms “coupled” and “connected,” along with their derivatives, can be used herein to describe structural relationships between components. It should be understood that these terms are not intended as synonyms for each other. Rather, in particular embodiments, “connected” can be used to indicate that two or more elements are in direct contact with each other. Unless otherwise made apparent in the context, the term “coupled” can be used to indicate that two or more elements are in either direct or indirect (with other intervening elements between them) contact with each other, or that the two or more elements co-operate or interact with each other (e.g., as in a cause-and-effect relationship, such as for signal transmission/reception or for function calls), or both.

The present disclosure provides examples of robotic systems capable of transferring objects from a first location to a second location. In particular, robotic systems described herein are configured for receiving an object at a loading or pick-up location and transferring the object to a container where it may be stacked with other objects. In a particular example, robotic systems described herein may facilitate the loading of aircraft luggage containers by receiving objects (e.g., luggage) at a pick-up location (e.g., a conveyor belt) and transferring the object to a luggage container where it may be stack inside with other objects.

Transferring of luggage to a luggage container may face several specific challenges. Traditional luggage loading tools include a single conveyor belt with no side supports. This design may create several challenges. First, luggage may fall off during transfer as it may not be well supported. Second, because the single conveyor belt can operate only in a forward or backward direction, the ability to place the luggage in any position within the airline shipping container may be compromised. Some shipping containers include walls and an opening, which can exacerbate this challenge, as it is difficult to place luggage in positions behind the walls. This lack of flexibility in traditional luggage loaders may result in lower packing density of shipping containers as well as greater time spent loading as the robotic systems attempt to place each piece of luggage. Further, traditional systems lack the ability to properly orient luggage pieces before loading these onto the conveyor loader. This may result in pieces falling during transfer and/or may increase the difficulty of accurately placing these objects. These and other challenges are addressed by object loaders and methods of their use as described herein.

Object loaders as described herein may include both a forwards-backwards conveyor and a side-to-side swiper arm. These features allow greater support for objects during transfer, greater speed of container packing, better alignment of objects prior to release, closer packing of objects within a container, and more flexibility in placing objects within the shipping container. Other aspects of object loaders described herein may provide a smaller overall object loader, which may increase object placement capabilities. These and other advantages are described in greater detail below.

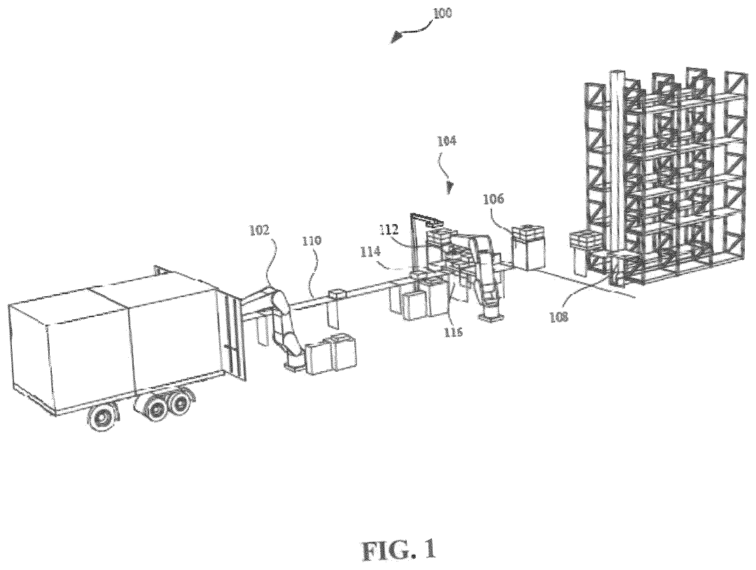

FIG. 1 is an illustration of an example environment in which a robotic system 100 with a coordinated transfer mechanism may operate. The robotic system 100 can include and/or communicate with one or more units (e.g., robots) configured to execute one or more tasks. Aspects of the coordinated transfer mechanism can be practiced or implemented by the various units.

For the example illustrated in FIG. 1, the robotic system 100 can include loading unit 102, a transfer unit 104 (e.g., which may include a repositioning robot), a transport unit 106, unloading unit 108, or a combination thereof in a warehouse or a distribution/shipping hub. Each of the units in the robotic system 100 can be configured to execute one or more tasks. The tasks can be combined in sequence to perform an operation that achieves a goal, such as to load objects into a truck, van, or container that were stored in a warehouse or to load objects from storage locations and prepare them for shipping. In some embodiments, the task can include placing the objects on or in a target location (e.g., on top of a pallet and/or inside a bin/cage/box/case). As described in detail below, the robotic system 100 can derive individual placement locations/orientations, calculate corresponding motion plans, or a combination thereof for placing and/or stacking the objects. Each of the units can be configured to execute a sequence of actions (e.g., operating one or more components therein) to execute a task.

In some embodiments, the task can include manipulation (e.g., moving and/or reorienting) of a target object 112 (e.g., one of the packages, boxes, cases, cages, pallets, etc. corresponding to the executing task) from a start/source location 116 to a task/destination location 114. For example, the loading unit 102 (e.g., a packing robot) can be configured to transfer the target object 112 into a location in a carrier (e.g., a truck) from a transferring location 110 (e.g., from a conveyor). The transfer unit 104 can be configured to transfer the target object 112 from one location (e.g., the conveyor, a pallet, a bin, etc.) to another location (e.g., a conveyor, a pallet, a bin, etc.). For another example, the transfer unit 104 (e.g., a palletizing robot) can be configured to transfer the target object 112 from a source location (e.g., a pallet, a pickup area, and/or a conveyor) to a destination pallet. The transport unit 106 (e.g., a conveyor, an automated guided vehicle (AGV), a shelf-transport robot, etc.) can transfer the target object 112 to an area associated with the transfer unit 104 from an area associated with the unloading unit 108, and the unloading unit 108 can transfer the target object 112 (by, e.g., moving the pallet or tray carrying the target object 112) to the transfer unit 104 from a storage location (e.g., a location on the shelves). Details regarding the task and the associated actions are described below.

For illustrative purposes, the robotic system 100 is described in the context of a packaging and/or shipping center; however, it is understood that the robotic system 100 can be configured to execute tasks in other environments/for other purposes, such as for manufacturing, assembly, storage/stocking, healthcare, and/or other types of automation. It is also understood that the robotic system 100 can include other units, such as manipulators, service robots, modular robots, etc., not shown in FIG. 1. For example, in some embodiments, the robotic system 100 can include a depalletizing unit for transferring the objects from cage carts or pallets onto conveyors or other pallets, a container-switching unit for transferring the objects from one container to another, a packaging unit for wrapping/casing the objects, a sorting unit for grouping objects according to one or more characteristics thereof, a piece-picking unit for manipulating (e.g., for sorting, grouping, and/or transferring) the objects differently according to one or more characteristics thereof, or a combination thereof.

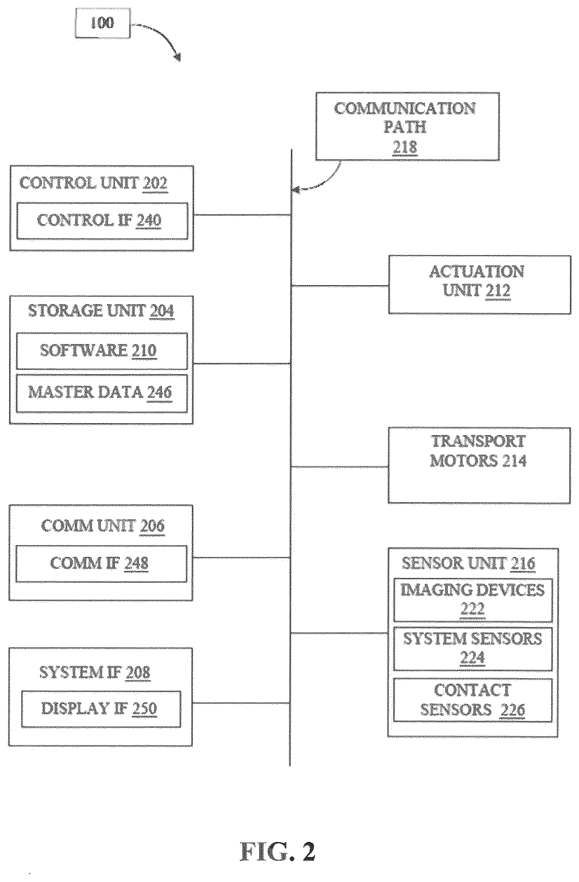

FIG. 2 is a block diagram illustrating the robotic system 100 in accordance with one or more embodiments of the present technology. In some embodiments, for example, the robotic system 100 (e.g., at one or more of the units and/or robots described above) can include electronic/electrical devices, such as one or more processors 202, one or more storage devices 204, one or more communication devices 206, one or more input-output devices 208, one or more actuation devices 212, one or more transport motors 214, one or more sensors 216, or a combination thereof. The various devices can be coupled to each other via wire connections and/or wireless connections. For example, the robotic system 100 can include a bus, such as a system bus, a Peripheral Component Interconnect (PCI) bus or PCI-Express bus, a HyperTransport or industry standard architecture (ISA) bus, a small computer system interface (SCSI) bus, a universal serial bus (USB), an IIC (I2C) bus, or an Institute of Electrical and Electronics Engineers (IEEE) standard 1394 bus (also referred to as “Firewire”). Also, for example, the robotic system 100 can include bridges, adapters, processors, or other signal-related devices for providing the wire connections between the devices. The wireless connections can be based on, for example, cellular communication protocols (e.g., 3G, 4G, LTE, 5G, etc.), wireless local area network (LAN) protocols (e.g., wireless fidelity (Wi-Fi)), peer-to-peer or device-to-device communication protocols (e.g., Bluetooth, Near-Field communication (NFC), etc.), Internet of Things (IoT) protocols (e.g., NB-IoT, LTE-M, etc.), and/or other wireless communication protocols.

The processors 202 can include data processors (e.g., central processing units (CPUs), special-purpose computers, and/or onboard servers) configured to execute instructions (e.g., software instructions) stored on the storage devices 204 (e.g., computer memory). In some embodiments, the processors 202 can be included in a separate/stand-alone controller that is operably coupled to the other electronic/electrical devices illustrated in FIG. 2 and/or the robotic units illustrated in FIG. 1. The processors 202 can implement the program instructions to control/interface with other devices, thereby causing the robotic system 100 to execute actions, tasks, and/or operations.

The storage devices 204 can include non-transitory computer-readable mediums having stored thereon program instructions (e.g., software). Some examples of the storage devices 204 can include volatile memory (e.g., cache and/or random-access memory (RAM)) and/or non-volatile memory (e.g., flash memory and/or magnetic disk drives). Other examples of the storage devices 204 can include portable memory and/or cloud storage devices.

In some embodiments, the storage devices 204 can be used to further store and provide access to processing results and/or predetermined data/thresholds. For example, the storage devices 204 can store master data 252 that includes descriptions of objects (e.g., boxes, cases, and/or products) that may be manipulated by the robotic system 100. In one or more embodiments, the master data 252 can include a dimension, a shape (e.g., templates for potential poses and/or computer-generated models for recognizing the object in different poses), a color scheme, an image, identification information (e.g., bar codes, quick response (QR) codes, logos, etc., and/or expected locations thereof), an expected weight, other physical/visual characteristics, or a combination thereof for the objects expected to be manipulated by the robotic system 100. In some embodiments, the master data 252 can include manipulation-related information regarding the objects, such as a center-of-mass (CoM) location on each of the objects, expected sensor measurements (e.g., for force, torque, pressure, and/or contact measurements) corresponding to one or more actions/maneuvers, or a combination thereof.

The communication devices 206 can include circuits configured to communicate with external or remote devices via a network. For example, the communication devices 206 can include receivers, transmitters, modulators/demodulators (modems), signal detectors, signal encoders/decoders, connector ports, network cards, etc. The communication devices 206 can be configured to send, receive, and/or process electrical signals according to one or more communication protocols (e.g., the Internet Protocol (IP), wireless communication protocols, etc.). In some embodiments, the robotic system 100 can use the communication devices 206 to exchange information between units of the robotic system 100 and/or exchange information (e.g., for reporting, data gathering, analyzing, and/or troubleshooting purposes) with systems or devices external to the robotic system 100.

The input-output devices 208 can include user interface devices configured to communicate information to and/or receive information from human operators. For example, the input-output devices 208 can include a display 210 and/or other output devices (e.g., a speaker, a haptics circuit, or a tactile feedback device, etc.) for communicating information to the human operator. Also, the input-output devices 208 can include control or receiving devices, such as a keyboard, a mouse, a touchscreen, a microphone, a user interface (UI) sensor (e.g., a camera for receiving motion commands), a wearable input device, etc. In some embodiments, the robotic system 100 can use the input-output devices 208 to interact with the human operators in executing an action, a task, an operation, or a combination thereof.

The robotic system 100 can include physical or structural members (e.g., robotic manipulator arms) that are connected at joints for motion (e.g., rotational and/or translational displacements). The structural members and the joints can form a kinetic chain configured to manipulate an end-effector (e.g., the gripper or loader) configured to execute one or more tasks (e.g., gripping, spinning, welding, etc.) depending on the use/operation of the robotic system 100. The robotic system 100 can include the actuation devices 212 (e.g., motors, actuators, wires, artificial muscles, electroactive polymers, etc.) configured to drive or manipulate (e.g., displace and/or reorient) the structural members about or at a corresponding joint. In some embodiments, the robotic system 100 can include the transport motors 214 configured to transport the corresponding units/chassis from place to place.

The robotic system 100 can include the sensors 216 configured to obtain information used to implement the tasks, such as for manipulating the structural members and/or for transporting the robotic units. The sensors 216 can include devices configured to detect or measure one or more physical properties of the robotic system 100 (e.g., a state, a condition, and/or a location of one or more structural members/joints thereof) and/or of a surrounding environment. Some examples of the sensors 216 can include accelerometers, gyroscopes, force sensors, strain gauges, tactile sensors, torque sensors, position encoders, etc.

In embodiments, for example, the sensors 216 can include one or more imaging devices 222 (e.g., visual and/or infrared cameras, 2D and/or 3D imaging cameras, distance measuring devices such as lidars or radars, etc.) configured to detect the surrounding environment. The imaging devices 222 can generate representations of the detected environment, such as digital images and/or point clouds, that may be processed via machine/computer vision (e.g., for automatic inspection, robot guidance, or other robotic applications). As described in further detail below, the robotic system 100 (via, e.g., the processors 202) can process the digital image and/or the point cloud to identify the target object 112 of FIG. 1, the start location 114 of FIG. 1, the task location 116 of FIG. 1, a pose of the target object 112, a confidence measure regarding the start location 114 and/or the pose, or a combination thereof. Imaging devices 222 associated with the robotic system 100 may be disposed and/or located in any appropriate position to perform the imaging/sensing discussed herein. In embodiments, imaging devices 222 may be located directly on moveable robotic systems, e.g., on the an object loader 500 and/or on any of the moving parts of the workpiece repositioner 600. In further embodiments, imaging devices 222 may be located in stationary locations suitably chosen to perform the necessary described sensing and/or imaging. Although, in some embodiments, specific locations and dispositions of imaging devices 222 may be discussed, these are provided by way of example only. Any suitable positioning for imaging devices 222 may be used to carry out or effect the operations, methods, processes, and systems described herein.

For manipulating the target object 112, the robotic system 100 (via, e.g., the various circuits/devices described above) can capture and analyze image data of a designated area (e.g., a pickup location, such as inside the truck or on the conveyor belt) to identify the target object 112 and the start location 114 thereof. Similarly, the robotic system 100 can capture and analyze image data of another designated area (e.g., a drop location for placing objects on the conveyor, a location for placing objects inside the container, or a location on the pallet for stacking purposes) to identify the task location 116. For example, the imaging devices 222 can include one or more cameras configured to generate image data of the pickup area and/or one or more cameras configured to generate image data of the task area (e.g., drop area). Based on the image data, as described below, the robotic system 100 can determine the start location 114, the task location 116, the associated poses, a packing/placement location, and/or other processing results. Details regarding the dynamic packing algorithm are described below.

In some embodiments, for example, the sensors 216 can include position sensors 224 (e.g., position encoders, potentiometers, etc.) configured to detect positions of structural members (e.g., the robotic arms and/or the end-effectors) and/or corresponding joints of the robotic system 100. The robotic system 100 can use the position sensors 224 to track locations and/or orientations of the structural members and/or the joints during execution of the task.

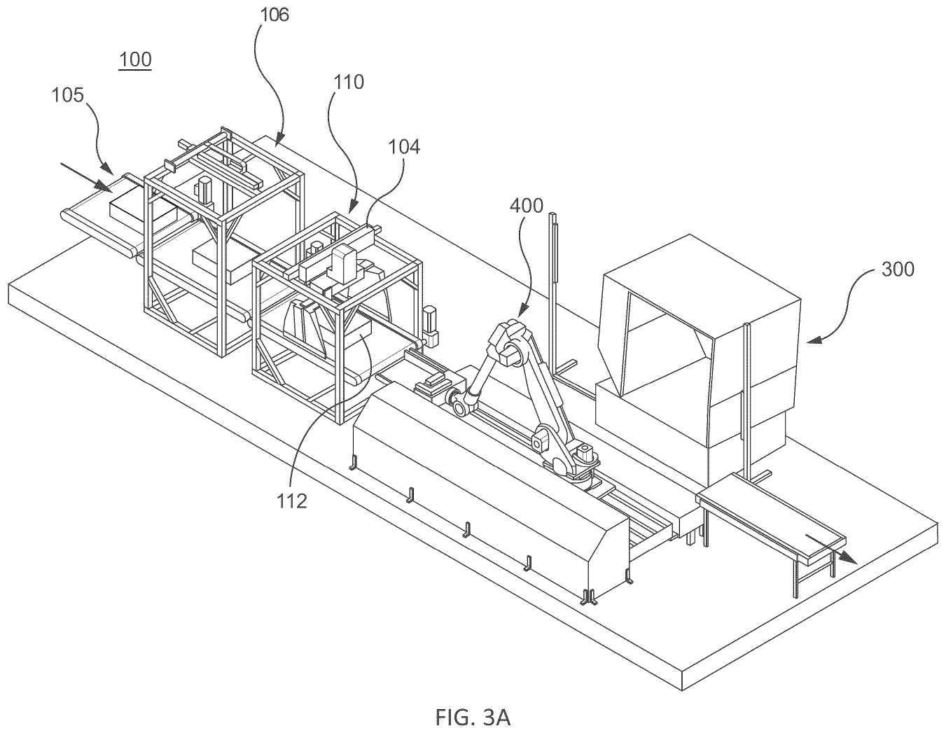

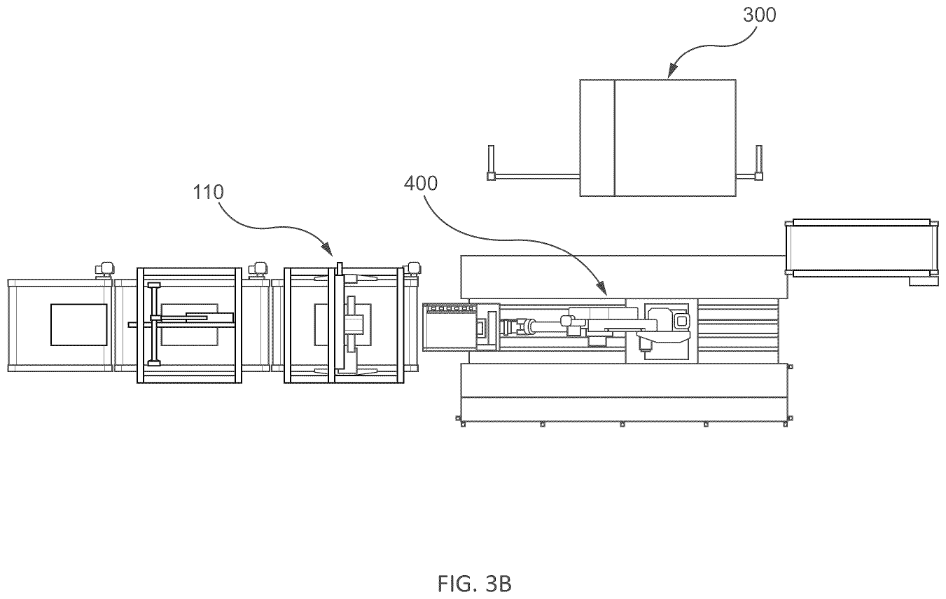

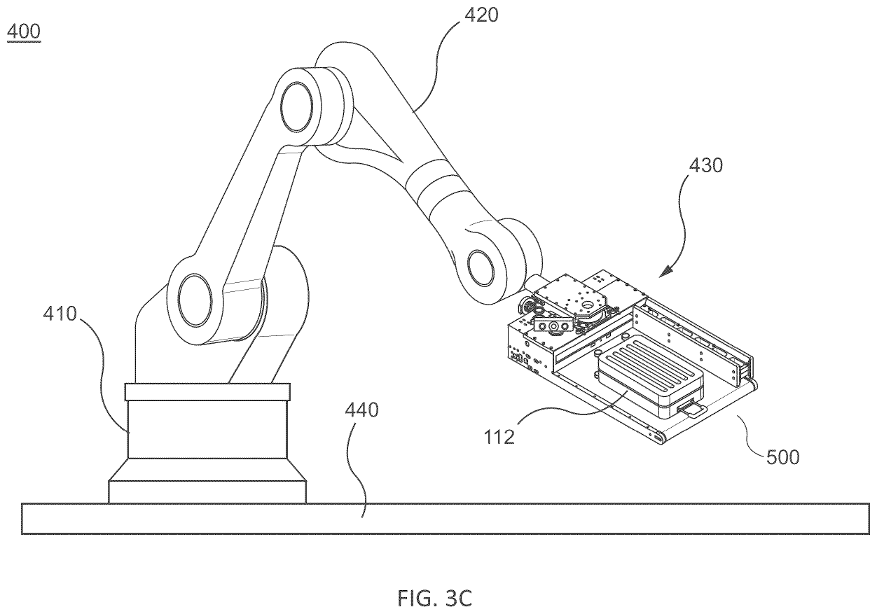

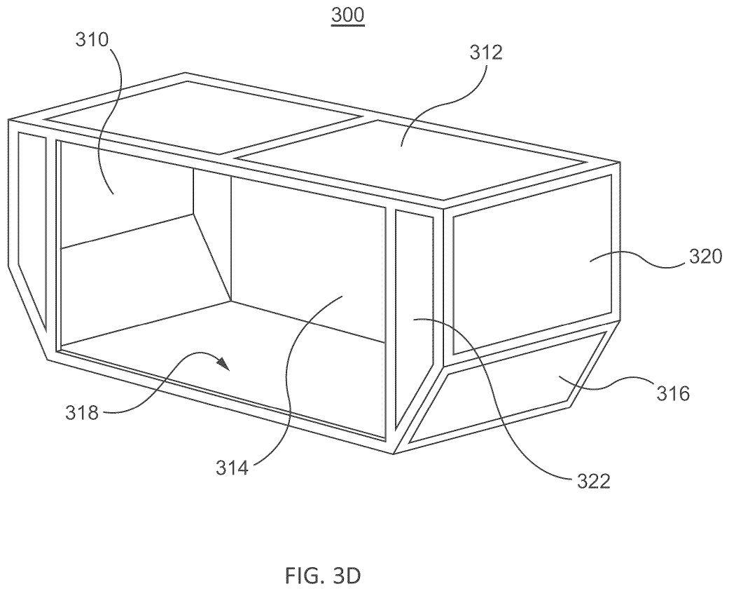

FIGS. 3A-3D depict a general overview of a portion an embodiment of a robotic system 100. FIGS. 3A and 3B illustrate the system as a whole while FIGS. 3C and 3D illustrate individual aspects of the system. This example portion of the robotic system 100 includes a feed conveyor 105, a pretransfer conveyor 106, transferring location 110, robotic system 400, and a container 300. A conveyor 111 is being used as an embodiment of a transferring location 110 in this example. This conveyor 111 is configured to transfer an object, such as a workpiece, in this example luggage W, from a storage location. As used herein, “workpiece” refers to an object or target object which a robotic system may work with, e.g., transfer, load, deposit, locate, etc. The robotic system 400 is configured to transfer the luggage W from the conveyor 111 to a container 300 (in this example an airline cargo container). The container is an embodiment of the above-mentioned carrier and the luggage W is an example of the target object. Other objects may be used as the carrier and target object in other embodiments.

The robotic system 400 includes a robot base 410, a robotic arm 420, an end of arm tool 430, and a robot slide 440. The robot base 410, robotic arm 420, end of arm tool 430, and robotic slide 440 are configured to work in tandem to convey the luggage W from the transferring location 110 to the container. Further description of these operations are provided below.

The container 300 is an airline cargo container in this example. These types are containers are often configured to have rigid sides and fit within the body of an airplane. The container 300 in FIG. 3C includes a container top wall 312, container side walls 314, container sloped wall sections 316, a container lower wall 318, a container back wall 320, and container front walls 322. These walls generally form a rigid structure for storing various items, such as luggage W. The container 300 may also have a container opening 310, through which luggage W may be loaded, either manually or by aid of the robotic system 400, for storage within the container 300.

As depicted in FIG. 3C, an embodiment of an end of arm tool 430 may be an object loader 500. The object loader 500 may also be referred to as a belt gripper. The object loader 500 is configured to aid the robotic system 400 with transferring target objects 112, such as luggage W, from the conveyor 111 to the container 300. The end of arm tool 430 could be other types of grippers or tools (e.g., claws, pinchers, scoops, rods, vacuum heads, etc.), depending on the desired target object 112 to be transferred. Additionally, the robotic system 400 may be configured to change the end of arm tool 430 during the course of loading the container 300 to better accommodate the specific target object 112 that is to be transferred.

FIG. 3D depicts one embodiment of a type of container into which target object (s) 112 may be loaded. In this particular embodiment, the container 300 is an airline container into which items such as suitcases are to be loaded. The container 300 may include a container opening 310 located on a front thereof. The container opening 310 may open in a direction perpendicular to the ground and may or may not be disposed along the entire front of the container 300. The container 300 may also include a container top wall 312. The container top wall 312 may be located toward a top of the container 300 and may or may not be disposed along the entire top of the container 300. The container 300 may also include a container side wall 314. The container side wall 314 may be generally disposed along a side of the container 300 and may or may not be disposed along the entire side of the container 300. The container 300 may also include a container sloped wall section 316. The container sloped wall section 316 may be generally located toward a side of the container 300 and may or may not be disposed along the entire side of the container 300. The container may also include a container back wall 320. The container back wall 320 may be disposed toward a back of the container 300 and may or may not be disposed along the entire back of the container 300. The container 300 may include a container front wall 322. The container front wall 322 may be disposed toward a front of the container 300 and may or may not be disposed along the entire front of the container 300.

The container into or onto which a workpiece or object is to be loaded is not limited to the above-described container. Any suitable container may be utilized, and may depend on the workpiece to be loaded and/or the transportation method by which the container is to be moved. For example, a suitable container may be one in which the bottom, front, back, and side walls are solid and continuous, with an opening being disposed only at the top thereof. As another example, the container may have a hinged top surface and an opening along the side thereof. However, the side may be temporarily closed, thereby restricting access thereto. As still another example, all of the surfaces of the container may be solid and continuous. However, at least a portion of one or more surface may be hinged or temporarily accessible so as to provide an opening into which the workpiece may be placed.

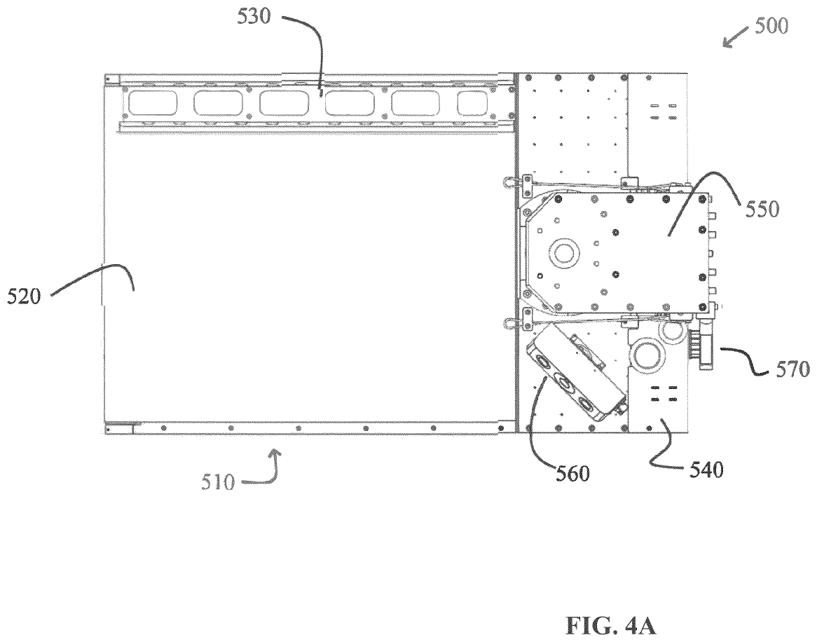

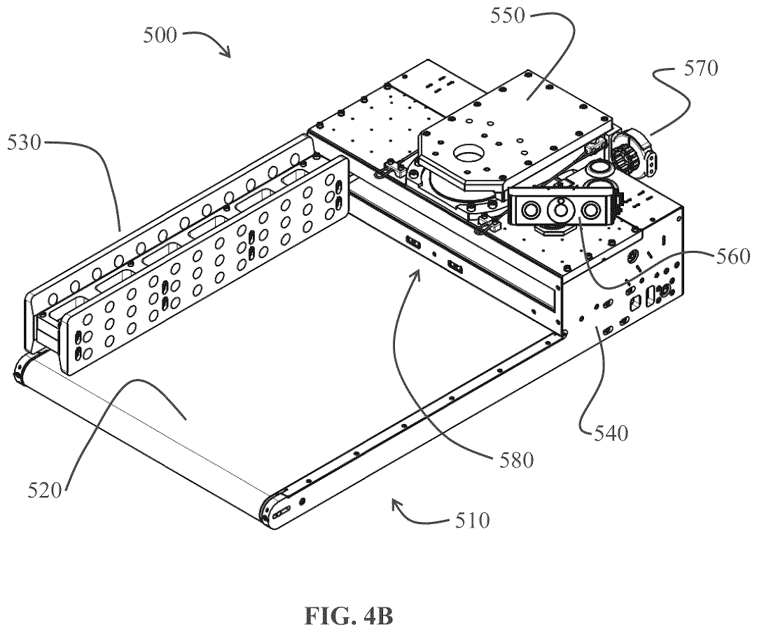

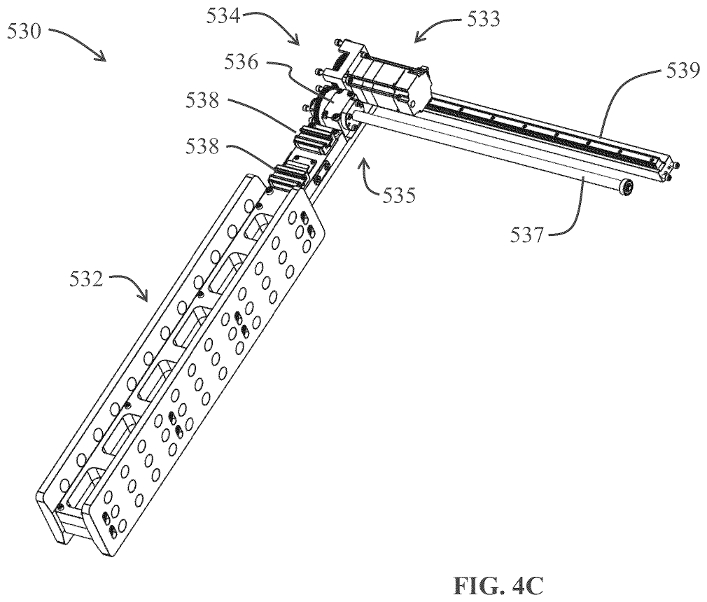

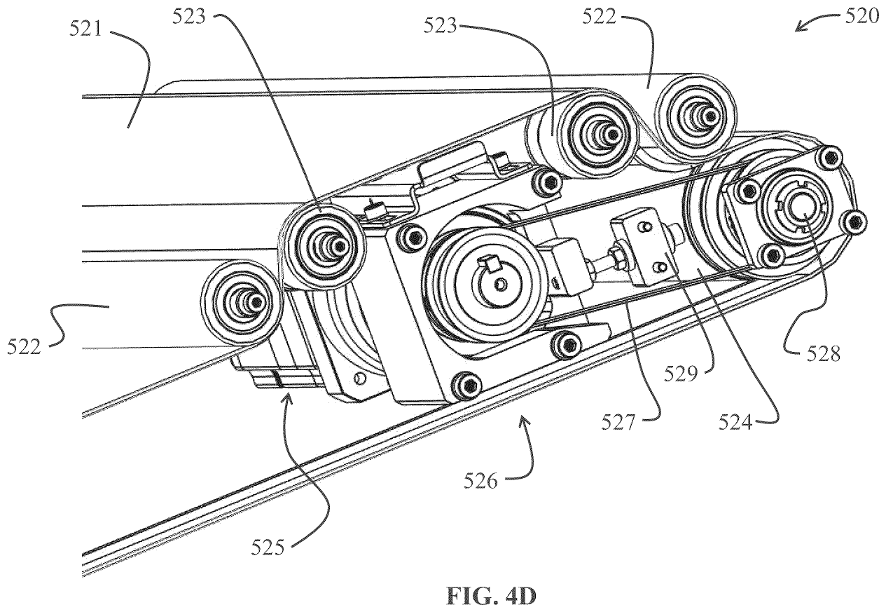

As described in this disclosure, various embodiments of an end of arm tool or effector may function as an object loader for loading a workpiece or object into a container. An embodiment of the end of arm tool is described with reference to FIGS. 4A-4D. FIG. 4A is a top view of the object loader 500, consistent with embodiments hereof. FIG. 4B is a perspective view of the object loader 500, consistent with embodiments hereof FIG. 4C illustrates a slider arm, consistent with embodiments hereof FIG. 4D illustrates a drive system of the object loader, consistent with embodiments hereof. In embodiments, the object loader 500 (also referred to as a belt gripper) generally includes a loader chassis 510, loader conveyor 520, loader swiper system 530, loader component housing 540, loader connector 550, and loader cable management system 570. Optionally, the object loader 500 may include a loader vision system 560. In further embodiments, the robotic system 400 may operate in conjunction with a vision system located off-hand, e.g., in a location remote from the robotic arm 420 or the object loader 500. Such a vision system may be stationary and/or may be disposed on a separate robotic arm or robotic mechanism.

In embodiments, the loader chassis 510 may be generally configured to support the other components of the object loader 500. The loader chassis 510 may be made of any suitable material, such as aluminum, stainless steel, rigid plastic, etc.

In embodiments, the object loader 500 may include a loader conveyor 520. The loader conveyor 520 may be configured to move a workpiece loaded onto the object loader 500 with at least one degree of freedom. For example, the loader conveyor 520 may configured to move a workpiece in a frontward and backward (e.g., longitudinal) direction relative to the object loader 500. As used herein, directions “relative” to the object loader may include a longitudinal direction (front-back), a lateral direction (left-right), and a normal direction (up-down). These directions are orthogonal to one another. Frontwards and backwards refer to directions away from and towards the mounting point of the object loader to the robotic arm, respectively. Lateral directions refer to directions orthogonal to the mounting point. Normal directions refer to direction perpendicular to the plane of the loader conveyor 520. The directions provided and used for discussion in this specification are relative directions provided to facilitate understanding and are not limiting. For example, in embodiments, longitudinal, lateral, and normal may be understood relative to a direction of travel of the loader conveyor (longitudinal) in embodiments where the loader conveyor is unidirectional. An embodiment of such a system is a belt conveyor, an example of which will be described in greater detail below. In embodiments, the loader conveyor 520 may be capable of moving the workpiece with two degrees of freedom, for example in both a frontward-rearward direction and a leftward-rightward direction. This may be accomplished using a multi-directional or omni-directional transfer table of a wheeled conveyor system.

In embodiments, the object loader 500 may include a loader swiper system 530. The loader swiper system 530 may be used to move the workpiece in a lateral direction (e.g., the leftward-rightward) with respect to the object loader 500. For example, a swiper arm 532 may be actuated to apply a sideways or lateral force to the object. The loader swiper system 530 may be configured such that the swiper arm 532 is disposed on a left side of the object loader 500, a right side of the object loader 500, or at any position therebetween. The swiper arm 532 may be moved by any suitable method. In an embodiment, the swiper arm 532 is moved by a swiper actuator 534 being driven by a swiper motor 533. In further embodiments, the swiper actuator 534 may be driven by other types of actuator, including, for example, pneumatic devices, hydraulic devices, solenoids, linkages, spring actuators, etc.

In embodiments, the object loader 500 may include a loader component housing 540. The loader component housing 540 may be separately provided or may be part of the object loader 500 itself. The loader component housing 540 may be part of the object loader 500 and be generally supported by the loader chassis 510. The loader component housing 540 may be positioned at a suitable location, for instance toward a rear of the object loader 500. The loader component housing 540 may generally be used to house and protect various components of the object loader 500.

In embodiments, the object loader 500 may include a loader connector 550. The loader connector 550 may be used to connect the object loader 500 to another component of the system. For example, the loader connector 550 may be used to connect the object loader 500 to the robotic arm 420. The loader connector 550 may be of sufficient structure to provide sufficient support for both the object loader 500 and a component placed thereon. As shown, e.g., in FIG. 4B, the loader connector 550 may be located

In embodiments, the object loader 500 may include a loader vision system 560. The loader vision system 560 optionally be attached to one or more portions of the object loader 500 or may be located off-hand, e.g. remotely from the object loader 500 or the robotic system 400. The loader vision system 560 may be used to collect various image data. The loader vision system 560 may include a single camera (or camera array) for capturing 2D and/or 3D image data. As shown in FIG. 4B, the loader vision system 560 may be positioned on a top surface of the loader component housing 540. This location may be beneficial to reduce the chances of the loader vision system 560 getting damaged during operation/movement of the object loader 500. Depending on the image data to be collected by the loader vision system 560, the loader vision system 560 may include additional image capture components and/or may be positioned at other areas of the object loader 500. In embodiments, the vision system 560 may be angled upward of the top surface of the object loader 500. This may reduce the chances that the field of view of the loader vision system 560 is affected or blocked by the object loader 500 itself. In some embodiments, the vision system 560 may be used to obtain image data concerning the current load state of the container.

In embodiments, the object loader 500 may include a loader cable management system 570. The loader cable management system 570 may be used to manage cables, wires, tubes, etc. that are to be used for actuating various components of the object loader 500. For instance, the loader cable management system 570 may be used for routing cables toward the loader component housing 540 and/or the loader vision system 560. The loader cable management system 570 may be structured to reduce a strain on the cables, wires, tubes, etc. passing therethrough while additionally reducing the possibility that the cables, wires, tubes, etc. will become damaged or cause interference while the loader is being moved/operated.

In embodiments, the object loader 500 may include a loader workpiece sensor system 580. The loader workpiece sensor system 580 may be configured to sense a workpiece on the object loader 500 and/or to sense one or more parameters of the object loader 500. Sensing the workpiece or object on the object loader 500 may include sensing the location, the presence, the size and shape, and/or the weight of the object or workpiece. For example, the loader workpiece sensor system 580 may be configured to sense a location of the workpiece on the object loader 500. As another example, the loader workpiece sensor system 580 may be used to sense a proximity of the workpiece to a back wall of the object loader 500. As an example of an object loader parameter to be sensed, the loader workpiece sensor system 580 may be used to sense a location of the swiper arm 532. In some embodiments, the loader workpiece sensor system 580 may be located behind a back wall of the object loader 500, which may also correspond to a front wall of the loader component housing 540. Accordingly, the loader workpiece sensor system 580 may be located within the loader component housing 540. In further embodiments, the loader workpiece sensor system 580 may be located elsewhere in the object loader 500 and/or may have components distributed throughout the object loader 500. Depending on the type of workpiece and/or the location of workpiece to be detected, the loader workpiece sensor system 580 may be located at a different location of the object loader 500.

In embodiments, the loader workpiece sensor system 580 may include various sensing components and appropriate hardware and software to operate these. Sensing components consistent with embodiments hereof may include, for example, cameras, motion sensors, weight sensors, proximity sensors, laser rangefinders, radar based rangefinders, and any other appropriate technology. The loader workpiece sensor system 580 may include one or more control circuits or processors specific to it and/or may include electrical connections to one or mor control circuits or processors associated with the object loader 500 and/or with the robotic system 400.

FIG. 4C illustrates an embodiment of the loader swiper system 530. In embodiments of the loader swiper system 530, a swiper arm 532 may be used to apply a lateral force to the workpiece or target object for securing, displacing, and/or throwing the workpiece. The swiper arm 532 may be of sufficient height to secure the workpiece when the object loader 500 is tilted and/or as the object loader 500 is moving. For example, the swiper arm 532 may be approximately the same height as an upper portion of the loader component housing 540. In embodiments, the swiper arm may have a height selected relative to a thickness (or heigh when laying flat) of common suitcases. For example, the swiper arm may have height between two and twelve inches. The swiper arm 532 may also be structured to have sufficient height to allow it to apply a lateral force to the workpiece or target object, while also reducing the possibility that the swiper arm 532 will travel under the workpiece while attempting to apply a force to the workpiece. The swiper arm 532 may also be structured to minimize its height. For example, the swiper arm 532 may be structured so that there is a reduced chance that the swiper arm 532 will interfere (e.g., by contacting a container front wall 322 or a container top wall 312) with the object loader 500 entering the container 300 (e.g., via the container opening 310) and offloading the workpiece. A proximal side of the swiper arm 532 may be disposed within the loader component housing 540 and may be disposed toward a rearward side of the object loader 500. A distal side of the swiper arm 532 may extend out of the loader component housing 540 and extend toward a front side of the object loader 500. The swiper arm 532 may extend above and over substantially the entire length (in the front-back direction) of the loader conveyor 520.

In some embodiments of the object loader 500, the loader swiper system 530 may include a swiper motor 533. The swiper motor 533 may be any type of suitable rotational or linear motor and may be structured to cause the swiper arm 532 to move in a lateral direction of the object loader 500. The swiper motor 533 is configured with sufficient power and torque to move both the swiper arm 532 and a workpiece disposed on the loader conveyor 520. The swiper motor 533 may be substantially or entirely disposed within the loader component housing 540. The swiper motor 533 may be supported by the loader chassis 510 and/or the loader component housing 540 (e.g., attached to a side wall of the loader component housing 540).

In some embodiments of the object loader 500, the loader swiper system 530 may include a swiper actuator 534. The swiper actuator 534 may be configured to move the swiper arm 532 in a lateral direction. The swiper actuator 534 may be configured to receive a rotational force (motion) from the swiper motor 533 and convert it into a linear force (motion) for the swiper arm. The swiper actuator 534 may include an actuator nut 535, an actuator gear 536, and an actuator rod 537. The actuator nut 535 may be physically attached to the swiper arm 532 and may be configured to move integrally with the swiper arm 532. The actuator nut 535 may be internally threaded. The actuator gear 536 may be physically and rotationally attached to the loader chassis 510 and/or the loader component housing 540. The actuator gear 536 may be configured to remain linearly stationary as the swiper arm 532 laterally moves. The actuator rod 537 may be physically attached to the actuator gear 536 and be configured to rotate integrally with the actuator gear 536. The actuator rod 537 may be threaded and be configured to mesh with and rotate within the actuator nut 535. The actuator rod 537 may be physically supported by the loader chassis and/or loader component housing 540 at a distal end by a bearing. Actuating the swiper motor 533 may cause the actuator gear 536 to rotate. Since the actuator rod 537 is physically connected to the actuator gear 536, rotation of the actuator gear 536 causes the actuator rod 537 to rotate. As the actuator rod 537 may be threaded, rotation of the actuator rod 537 may cause the actuator nut 535 to move in a linear direction (e.g., along the length of the actuator rod 537). In further embodiments, the swiper arm 532 may be driven by any other suitable type of actuator, including linear motor(s), one or more solenoids, magnetic systems, hydraulic and/or pneumatic systems, etc.

In some embodiments of the belt loader, the loader swiper system 530 may include one or more swiper guide 538 and one or more swiper guide rail 539. In FIG. 4C, a pair of swiper guides 538 are shown. The swiper guides 538 may be physically attached to an upper surface of the swiper arm 532. The swiper guides 538 are each configured to travel along a swiper rail (not shown) as the swiper arm 532 moves in the lateral direction. The swiper guides 538 are configured to support, stabilize, and guide the swiper arm 532 as the swiper arm 532 moves in the lateral direction. The swiper guides 538 may be configured to move within the loader component housing 540 throughout the movement of the swiper arm 532. FIG. 4C also depicts a single swiper guide rail 539. The swiper guide rail 539 may be physically connected to the loader chassis 510 and/or the loader component housing 540. The swiper guide rail 539 may be configured to support, stabilize, and guide the swiper arm 532 as the swiper arm 532 moves in the lateral direction. For example, the swiper guide rail 539 may mesh with a swiper guide (not shown) physically connected to a proximal side of the swiper arm 532. The swiper guides 538 may include any suitable type of linear bearing or bearing surface to facilitate linear motion and the lateral translation of the swiper arm 532.

FIG. 4D illustrates an embodiment of the loader conveyor 520 of the object loader 500. The loader conveyor 520 may be configured to move a workpiece disposed thereon in a front-rear (forwards-backwards) direction of the object loader 500. The object loader 500 may include a loader belt 521. The loader belt 521 may a be a conveyor belt used to transfer a front-rear force to the workpiece. The loader belt 521 may have a sufficient surface friction allowing for the proper movement of the workpiece.

In embodiments, the loader conveyor 520 may include one or more bend pulley 522 and one or more reverse bend pulley 523. The bend pulley 522 and the reverse bend pulley 523 may be used for modifying the direction of the loader belt 521. For example, the bend pulleys 522 and the reverse bend pulleys 523 depicted in FIG. 4D are configured to direct the loader belt 521 around a conveyor drive motor 525. The bend pulley 522 and the reverse bend pulley 523 may be disposed within the loader component housing and may be supported by the loader chassis 510 and/or the loader component housing 540.

In embodiments, the loader conveyor 520 may include drive pulley 524. The drive pulley 524 may be configured to drive the loader belt 521. The drive pulley 524 may be disposed within the loader component housing 540 and be supported by the loader chassis 510 and/or the loader component housing 540. The drive pulley 524 may be disposed toward a rearward side of the object loader 500.

In, the loader conveyor 520 may include a conveyor drive motor 525. The conveyor drive motor 525 may be positioned within the loader component housing 540 and may be directly or indirectly supported by the loader chassis 510 and/or the loader component housing 540. The conveyor drive motor 525 may be positioned between a loop formed by the loader belt 521. Bending pulleys 522 and reverse bending pulleys 523 may be used to direct the loader belt 521 around the conveyor drive motor 525. The conveyor drive motor may be configured to provide a driving force for moving the loader belt 521 via the drive pulley 524. For instance, operating the conveyor drive motor 525 may cause the drive pulley 524 to rotate, which in turn operates the loader belt 521. As an example, a belt driver 526 may be used to transfer the force of the conveyor drive motor 525 toward the drive pulley 522. The belt driver 526 may aid in securing the conveyor drive motor 525 in relation to the loader component housing 540. The belt driver 526 may have a drive wheel configured to drive a drive belt 527. The drive belt 527 may transfer the rotational movement of the wheel of the belt driver 526 to a receiver wheel of a belt receiver 528. The belt receiver 528 may be connected to the drive pulley 522, such that the receiver wheel of the belt receiver 528 and the drive pulley 522 integrally rotate.

In embodiments, the loader conveyor 520 may include a belt tensioner 529. The belt tensioner 529 may be connected to the belt driver 526. Operating the belt tensioner 529 may cause the drive belt 527 to have an increased or decreased tension. The belt tensioner may include structure, such as a screw or bolt, that may be adjusted to increase or decrease the tension of the drive belt 527 by increasing or decreasing the distance between the belt driver 526 and the belt drive pulley 524.

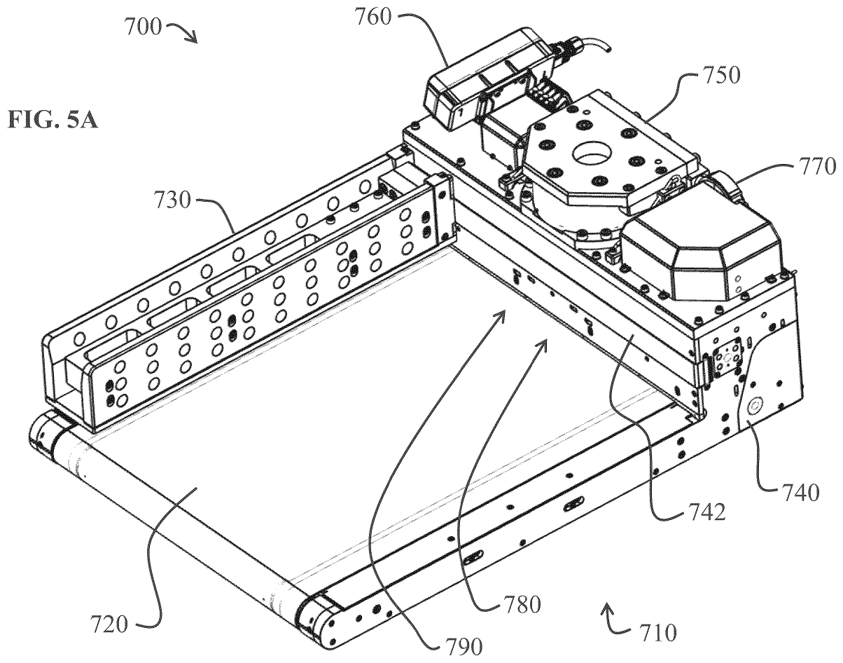

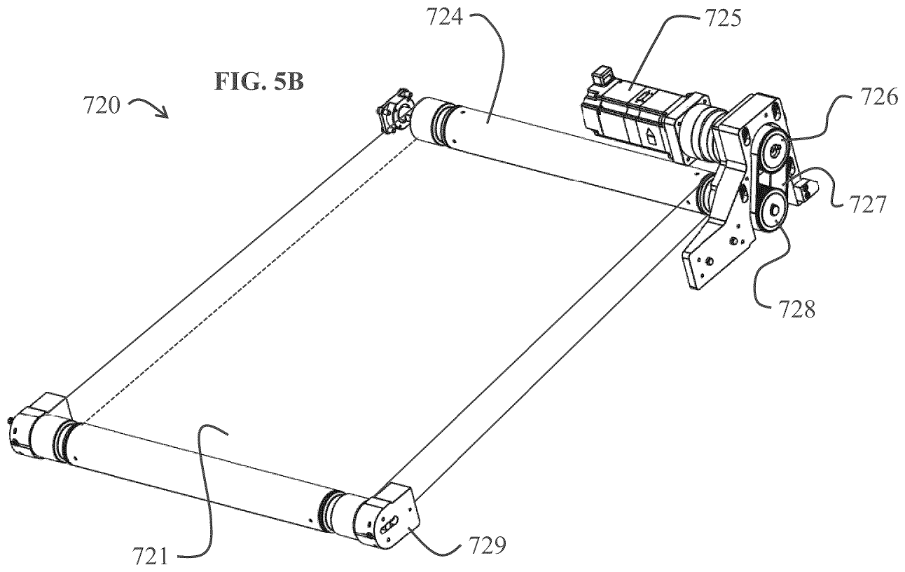

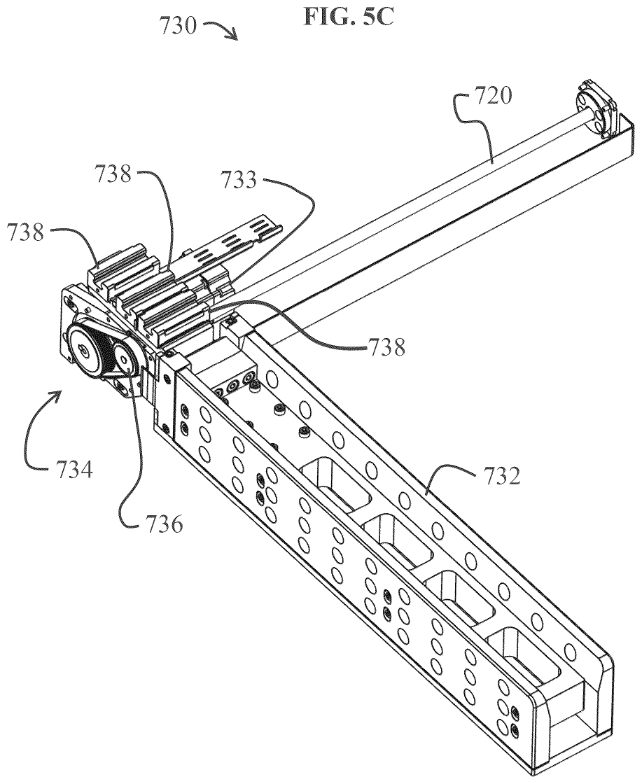

FIGS. 5A-5C illustrate another embodiment of an object loader. The object loader of FIGS. 5A-5C may include all of the same features as the object loader 500, except where differences are specifically described. The object loader 700 may have a smaller profile than the previously described object loader 500. Similar to the previously described object loader 500, this embodiment of the object loader 700 may include any or all of a loader chassis 710, loader conveyor 720, loader swiper system 730, loader component housing 740, loader connector 750, loader vision system 760, loader cable management structure 770, and loader workpiece sensor system 780. This embodiment of the belt loader may further include a swiper sensor system 790. As these components may have similar functions and/or structures as the previously described components, the details of each component may not be fully described.

In embodiments, the object loader 700 may include a loader conveyor 720. The loader conveyor 720 may include a loader belt 721, a drive pulley 724, a conveyor drive motor 725, a belt driver 726, a drive belt 727, a belt receiver 728, and a belt tensioner 729. The key difference between the object loader 500 and the object loader 700 is the positioning of the conveyor drive motor 725. The conveyor drive motor 725 of the loader conveyor 720 may be positioned outside of a loop created by the loader belt 721. For instance, the conveyor drive motor 725 may be positioned above the drive pulley 724. This arrangement serves to reduce the number of pulleys used for directing the loader belt 721, because no pulleys are necessary to direct the loader belt 721 around the conveyor drive motor 725. This arrangement may further may reduce the amount of space taken up by the loader conveyor 720. Accordingly, the overall size of the object loader 700 may be reduced. The reduction in size of the object loader 700 may permit the object loader 700 to be used in smaller or tighter spaces. Additionally, the reduction in the number of moving parts (e.g., bend pulleys) serves to simplify the design, making it more robust.

In embodiments, the object loader 700 may include a loader swiper system 730. The loader swiper system 730 may include any or all of a swiper arm 732, swiper motor 733, swiper actuator 734, actuator nut (not shown), actuator gear 736, actuator rod 737, and swiper guide 738. In this embodiment of the loader swiper system 730, the swiper guides 738 may be located above the swiper motor 733 and the actuator rod 737. Accordingly, the overall length of the loader swiper system 730 may be reduced, which in turn allows the overall length of the object loader 700 to be reduced.

In embodiments, the object loader 700 may include a loader component housing 740. The loader component housing 740 may include a front wall opening cover 742. The front wall opening cover 742 may be configured in various ways, such as a stationary or moveable flat belt, a brush, etc. The front wall opening cover 742 may be configured to close or block an opening in the loader component housing 740 through which the swiper arm 732 passes and travels along. A front wall of the loader component housing 740 may also have openings for the loader workpiece sensor system 780 and the swiper sensor system 790 to transmit and receive a signal. The loader workpiece sensor system 780 may be configured to sense a position of a workpiece. The swiper sensor system 790 may be configured to sense a position of the swiper arm 732.

As discussed above, the robotic transfer system 100 may include a transfer unit 104. The transfer unit 104 is configured to receive a target object 112 (e.g., a workpiece) from a transportation unit 106 or other source, and prepare the target object 112 for pick-up or reception by the robotic loading system 400. In embodiments, the transfer unit 104 may include a workpiece repositioner 600. The workpiece repositioner 600 may be configured to reposition a target object or workpiece W. For instance, the workpiece W may be repositioned to better align with various components of the transfer unit 104 and/or may be repositioned to facilitate loading onto the object loader 500/700. As an example, the workpiece repositioner 600 may reposition the workpiece W in the yaw direction so that it better aligns with the conveyor 111. As used herein, the “yaw direction” refers to rotational movement in the horizontal (or lateral) or lateral plane. Repositioning in the yaw direction may serve to better orient the target object on the transfer unit 104, e.g., so that pair of sides of the target object run parallel the direction of movement of the transfer unit 104 and/or the object loader 500 on which the target object is to be loaded. The workpiece repositioner 600 may also adjust the location of the workpiece on the conveyor 111. The workpiece repositioner 600 may adjust the location and/or rotation of the workpiece W before the workpiece is loaded onto the loader.

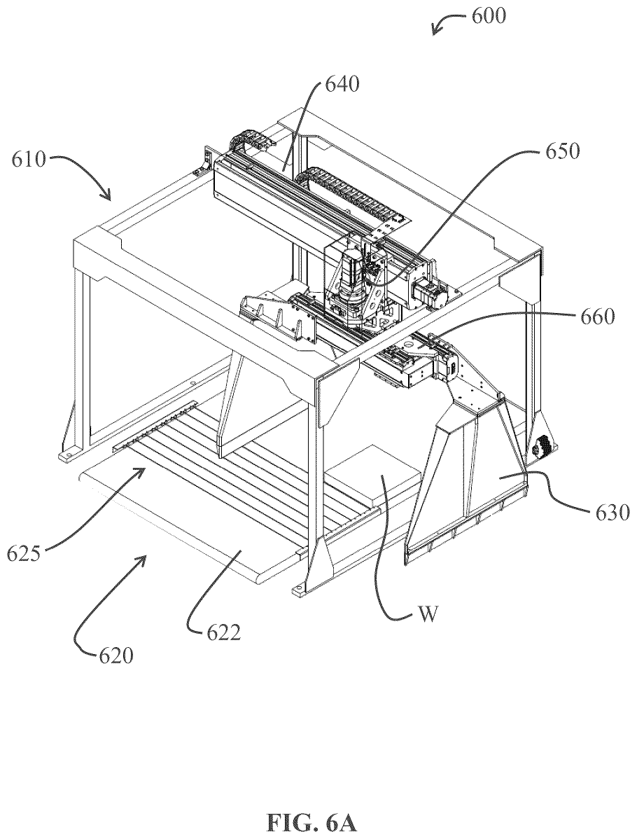

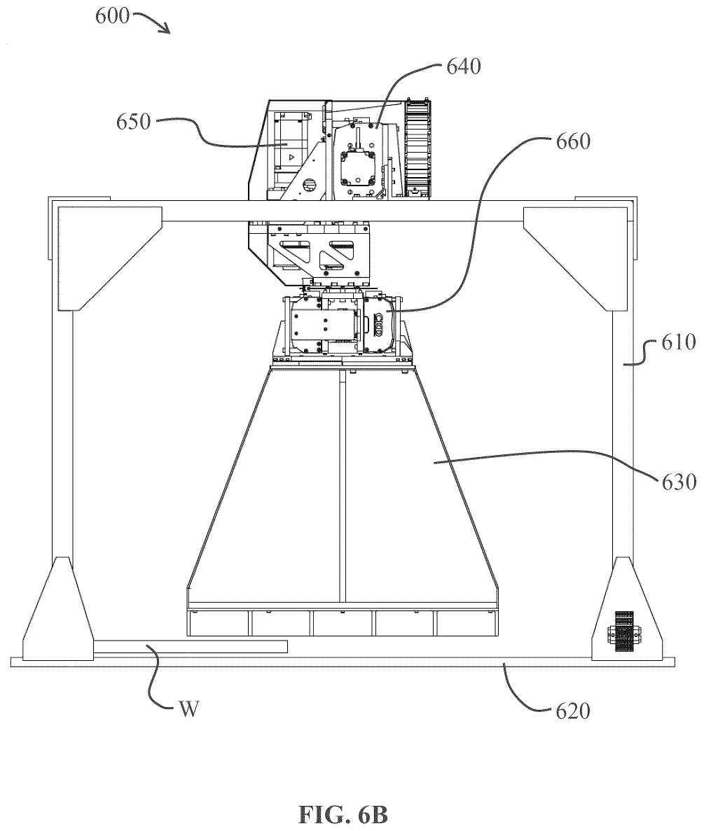

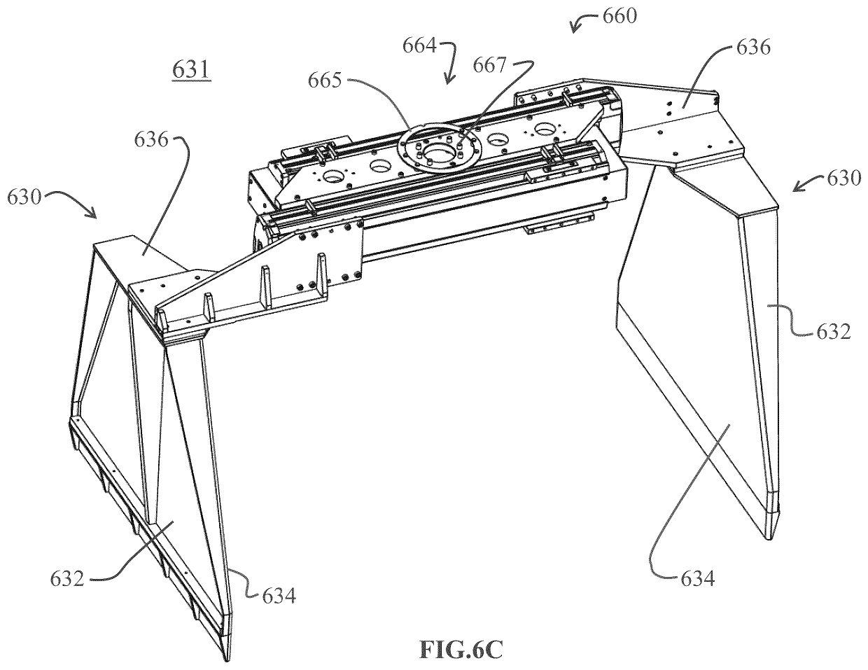

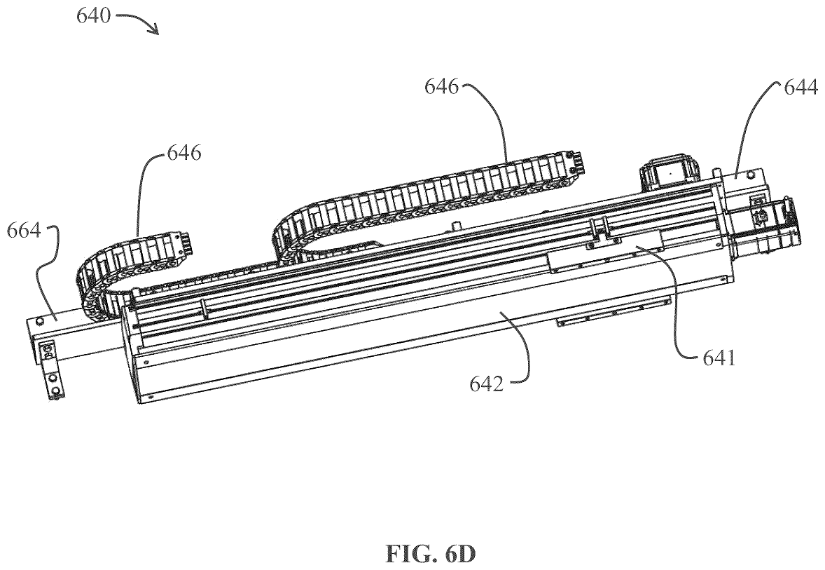

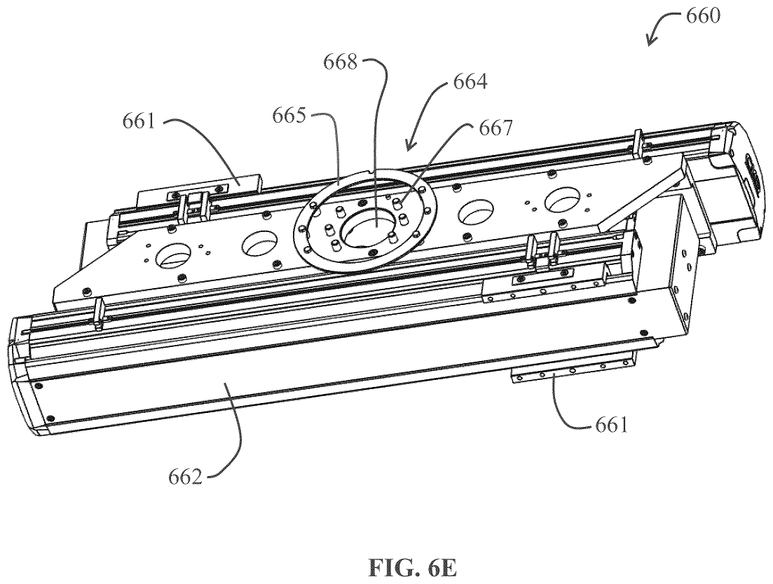

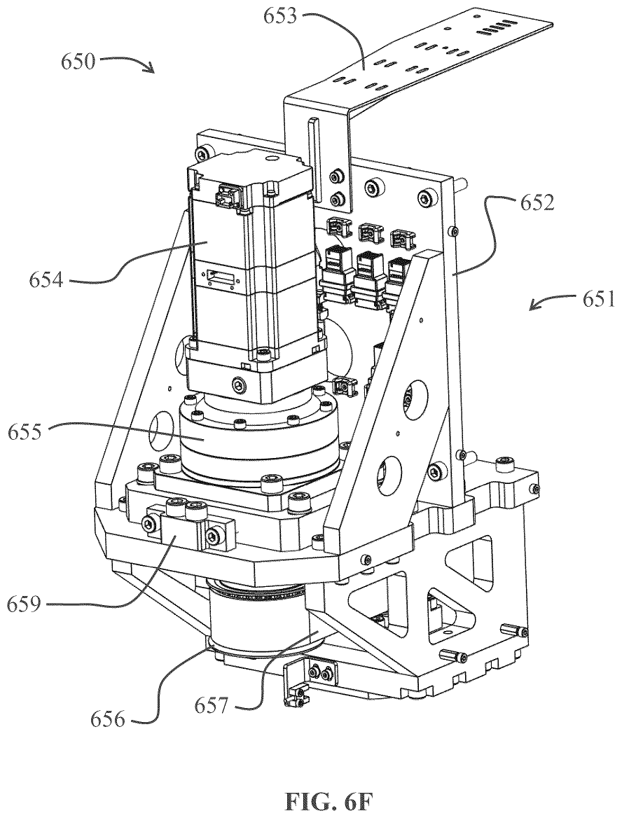

FIGS. 6A-6F depict an embodiment of a workpiece repositioner 600. This embodiment may be generally described as a repositioning tool supported by and moveable with respect to a gantry. The workpiece repositioner 600 may include a gantry frame 610, a repositioner conveyor 620, a repositioning blade assembly 631 including one or more repositioning surfaces 630, a gantry actuator 640, a rotational actuator 650, and a linear actuator 660.

In embodiments, the workpiece repositioner 600 may include a gantry frame 610. The gantry frame 610 may be used for supporting one or more component of the workpiece repositioner 600. For example, the gantry frame 610 may be formed into a generally boxed shaped bridging structure. The gantry frame 610 may have sufficient dimensions to allow for workpieces to pass under and between various portions of the gantry frame 610.

In embodiments, the workpiece repositioner 600 may include a repositioner conveyor 620. The repositioner conveyor 620 may pass between and under the gantry frame 610. The repositioner conveyor 620 may be structured to support a workpiece thereon and to convey the workpiece in a linear direction underneath the gantry frame 610. The repositioner conveyor 620 may include a repositioner conveyor belt 622 and/or any other suitable linear movement structure (rollers, etc.) The repositioner conveyor 620 may further include one or more conveyor sensor 625. In some embodiments, the conveyor sensor can be used to determine a location or a size of a workpiece disposed on the repositioner conveyor belt 622. Such a conveyor sensor 625 may be configured as a laser sensor, photodiode sensor, optical sensor, camera, or any other suitable sensor.

In embodiments, the workpiece repositioner 600 may include a repositioning blade assembly 631 having one or more repositioning surfaces 630. An embodiment of a repositioning surface 630 is shown in FIG. 6C. In FIG. 6C, two repositioning surfaces 630 are provided. The repositioning surfaces 630 may each include a repositioning blade 632. The repositioning blade 632 may have a length and width sufficient to contact a workpiece or target object and cause the workpiece to be moved in a linear and/or rotational direction. The repositioning blade 632 may have a blade surface 634. The blade surface 634 may be configured to contact the workpiece while minimizing damage to the workpiece.

The repositioning blade assembly 631 and the repositioning surfaces 630 may be suspended from the gantry frame 610 and driven by a series of actuators, each configured to cause translational or rotational movement of the repositioning surfaces. One or more linear actuators 660 may be configured to linearly translate, e.g., provide linear motion to, the repositioning surfaces 630. A rotational actuator 650 may be configured to rotationally translate, e.g., provide rotational motion to, the repositioning blade assembly 631. Additionally, a gantry actuator 640 may be configured to provide translation motion to the repositioning blade assembly 631. The operation of these actuators is described in greater detail below. The repositioning blade assembly 631 and the actuators (linear actuators 660, rotation actuator 650, and gantry actuator 640) may be referred to herein as the repositioning gantry.

The repositioning blade 632 may be attached to the linear actuator 660 via a blade bracket 636. The repositioning blades 632 each extend from a respective blade bracket 636 in a substantially orthogonal direction. Each blade bracket 636 is connected to the linear actuator 660. The blade bracket 636 may be of sufficient strength and design to transfer a linear force from the linear actuator 660 to the repositioning blade 632 and to support the movement of both the repositioning blade 632 and workpiece along the repositioner conveyor belt 622. The linear actuator 660 may be, for example, a motor and leadscrew, a solenoid, one or more pneumatic or hydraulic devices, a rack and pinion device, and/or any other suitable structure for generating linear motion.

In embodiments, the workpiece repositioner 600 may include a gantry actuator 640. An embodiment of the gantry actuator 640 is shown in FIG. 6D. The gantry actuator 640 may be used to cause the workpiece disposed on the repositioner conveyor 620 to be located at a different location on the repositioner conveyor 620, e.g., via contact with the one or more repositioning blades 632. For example, the gantry actuator 640 may be configured to move various components of the workpiece repositioner 600, such as the rotational actuator 650, linear actuator 660, and the repositioning blade assembly 631. The gantry actuator 640 may cause these components to move in a left-right direction with respect the repositioner conveyor 620, which in turn may cause the workpiece to be repositioned in the left-right direction of the repositioner conveyor 620. The gantry actuator 640 may include a motor (not show) to cause a movement in a linear direction. In some embodiments, the gantry actuator 640 may include a mounting plate 641 and a linear opening 642. The mounting plate 641 may be configured to have the rotational actuator 650 mounted thereto. The linear opening 642 may be an opening through which the mounting plate 641 can be moved in a linear direction. The gantry actuator 640 may be mounted on the gantry frame 610 using one or more gantry motor brackets 644. The gantry motor brackets 644 may be of sufficient structure and design to support various components of the workpiece repositioner 600, for example, the gantry actuator 640, the rotational actuator 650, the linear actuator 660, and the repositioning surface 630. In embodiments, the gantry actuator 640 may also include one or more cable management conduits 646. Each cable management conduit 646 may be configured to manage cables traveling to various portions of the workpiece repositioner 600. For example, one cable management conduit 646 may be used to manage cables running to the rotational actuator 650. Such a cable management conduit 646 can prevent the cables running to the rotational actuator 650 from becoming damaged during linear movement of the rotational actuator 650, for example by the gantry actuator 640.

In embodiments, the workpiece repositioner 600 may include a rotational actuator 650. An embodiment of the rotational actuator 650 is shown in FIG. 6F. The rotational actuator 650 may be used to cause a pose of the workpiece to change. For example, the rotational actuator 650 may cause the workpiece to rotate about a yaw axis (e.g., a vertical rotational axis) of the workpiece. The rotational actuator 650 may be used to cause the workpiece to rotate relative to the loader conveyor 520. The rotational actuator 650 may physically connect to and be moved by the gantry actuator 640. For example, the rotational actuator 650 may include a rotational motor frame 651. The rotational actuator frame 651 may provide a support system for the components of the rotational actuator 650. The rotational actuator frame 651 may include a mounting plate 652. The mounting plate 652 may be configured to be mounted to the gantry actuator 640. A cable management plate 653 may be attached to the mounting plate 652. The cable management plate 653 may be used to guide cables for operating at least the rotational motor 654. The cable management plate 653 may also be attached to the cable management conduit 646. In some embodiments, the cable management plate 653 is capable of moving the cable management conduit 646 upon actuation of the gantry actuator 640. For instance, as the rotational actuator 650 is moved by the gantry actuator 640, the cable management plate 653 may cause various locations of the cable management conduit to be folded.

In embodiments, the rotational actuator 650 may include a rotational motor 654. The rotational motor 654 may be a source of force for causing the rotational actuator 650 to apply a rotational force to the positioner blade assembly 631. The rotational motor 654 may be mounted on the rotational actuator frame 651. Cables supported by the cable management plate 653 and/or the cable management conduit 646 may provide power and control to the rotational motor 654.

In embodiments, the rotational actuator 650 may include a gear box 655. The gear box 655 may be configured to transfer and/or convert the rotational movement of the rotational motor 654. For example the gear box 655 may be configured as a reduction gear. For instance, the gear box 655 may convert a rotational speed of the rotational motor 654 into an increased torque, for example by using a sun gear system. This has the benefit of increasing the torque that may be applied to the workpiece during rotational movement of the workpiece.

In embodiments, the rotational actuator 650 may include a driving wheel 656, a power transfer belt 657, and a driven wheel 658. This system of components may be used to transfer the power from the motor to linear actuator 660 for causing a rotation of the linear actuator 660 and the repositioning blade assembly 631. For instance, the driving wheel 656 may be connected to an output shaft of the gear box 655. The power transfer belt 657 may be connected to the driving wheel 656 and the driven wheel 658. The power transfer belt 657 may be configured to transfer power from the driving wheel 656 to the driven wheel 658. The driven wheel 658 may be configured to be connected to the linear actuator 660. Accordingly, power may be transferred from the rotational motor 654 to the linear actuator 660.

In embodiments, the rotational actuator 650 may include a belt tensioner 659. The belt tensioner 659 may be disposed on the rotational actuator frame 651. The belt tensioner 659 may include one or more screws or bolts and may be configured for tightening or loosening the power transfer belt 657.

In embodiments, the workpiece repositioner 600 may include a linear actuator 660. An embodiment of the linear actuator 660 is depicted in FIG. 6E. The linear actuator 660 may include one or more motors or other actuator (not shown) to cause linear movement. The linear actuator 660 may be configured to move the one or more repositioning surfaces 630 in a linear direction. For example, the linear actuator 660 may be used to move the repositioning surface 630 in the left-right direction relative to the repositioner conveyor 620. The linear actuator 660 may be connected to and supported by the rotational actuator 650, for instance by a connector 664. For example, in some embodiment, the connector 664 of the linear actuator 660 may include a mounting ring 665 and one or more mounting pin 667. The mounting ring 665 and the mounting pins 667 may be configured to engage the rotation actuator 650. For example, the mounting ring 665 and the mounting pins 667 may engage a portion of the driven wheel 658 of the rotational actuator 650. When rotated by the rotational actuator 650, the linear actuator 660 may be configured to move the repositioning surfaces 630 in any lateral direction with respect to the repositioner conveyor 620

In embodiments, the linear actuator 660 may include one or more mounting plate 661 and one or more linear opening 662. The mounting plate 661 may be configured to have a repositioning surface 630 attached thereto. The mounting plate 661 may be configured to move within the linear opening 662 of the linear actuator 660. By linearly moving the mounting plate 661, the linear actuator 660 may be configured to linearly dispose a repositioning surface 630. If the linear actuator includes two mounting plates 661, a repositioning surface 630 may be attached to each of the mounting plates 661. The mounting plates 661 may be moved independently by the linear actuator 660 so as to cause a distance between the repositioning surfaces 630 to increase or decrease. Accordingly, the linear actuator 660 may be used for applying a clamping force to the workpiece.

In embodiments, the linear actuator 660 may include a cable opening 668. The cable opening may be positioned within the connector 664 and may be configured to allow cables for operating the linear actuator 660 to pass therethrough. The cable opening 668 can receive the cable via the cable management conduit 646, cable management plate 653, through an interior of the driven wheel 658, or any combination thereof. In some embodiments, a sliding surface contact style connector may be provided to apply signals and power to the linear actuator 660. By providing such a style connector, the repositioning surface(s) 630 may be freely rotated without causing strain on the cables and without the need to reset the orientation of the repositioning surface(s) 630 between repositioning of workpieces. This also allows the repositioning surface(s) 630 to cause the workpiece to be rotated 180 degrees to better orientate the workpiece for loading into the container.

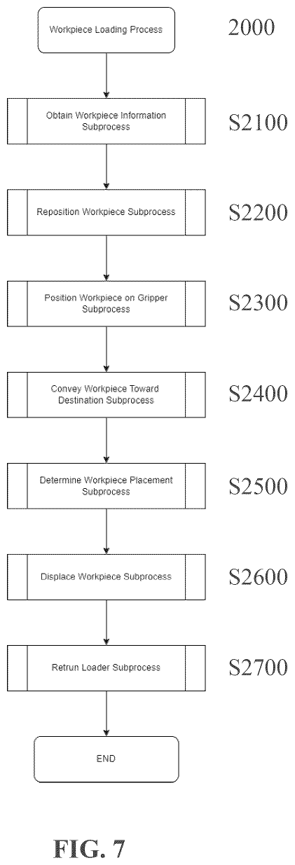

FIG. 7 provides an example embodiment of an overall workpiece loading process. This example process includes a number of subprocesses, which may be performed in various orders, simultaneously, or by omitting various subprocesses as is to be dictated by the workpiece to be loaded. In an embodiment, the subprocesses of the workpiece loading process 2000 includes an obtain workpiece information subprocess S2100, a reposition workpiece subprocess S2200, a position workpiece on loader subprocess S2300, a convey workpiece toward destination subprocess S2400, a determine workpiece placement subprocess S2500, a displace workpiece subprocess S2600, and a return loader subprocess S2700.

Any and all aspects of the workpiece loading process 2000 may be executed by the robotic system 100 and/or by any sub-portion of the robotic system 100 or any robotic system discussed herein. The workpiece loading process 2000, and all subprocesses, may be understood as a computer implemented process executed by software instructions controlling the various hardware and sensor systems described herein. In embodiments, the one or more control units/processors 202, interfacing with the one or more storage devices 204, one or more communication devices 206, and one or more input-output devices 208, may be operated to execute software instructions to control the various robotic hardware and sensor systems (e.g., transport unit 106, transfer unit 104, robotic system 400, etc.) described herein to carry out the various steps and processes discussed below with respect to the workpiece loading process 2000. In the discussion below of the workpiece loading process 2000 and its various subprocesses, multiple determination and/or decision making steps are discussed. In the various embodiments discussed below, these decision making steps may be carried out by the one or more control units/processors 202 executing software instructions. In some cases, such decisions are based on information, e.g., computer readable data collected by various sensors and cameras as discussed below and throughout. Such decisions may be understood as steps in a computer implemented control systems process. In the context of the processes described, the “system” refers to a system having one or more features in common with the robotic system 100 and being configured to control one or more robotic systems described herein.

As previously indicated, these subprocesses S2100-S2700 do not necessarily need to be performed in a certain order. Some of the subprocesses may be omitted to further improve efficiencies in certain situations. As an example of different ordering of the subprocesses, the determine workpiece placement subprocess S2500 may be performed immediately after the obtain workpiece information subprocess S2100 has been completed. As another example of the ordering of the determine workpiece placement subprocess S2500, this subprocess S2500 may be performed immediately before the convey workpiece toward destination subprocess S2400 has been performed. As an example of a subprocess that may be omitted in certain situation, the reposition workpiece subprocess S2200 may not be necessary in certain scenarios. As an example of subprocesses that may occur simultaneously, the position workpiece on loader S2300 and convey workpiece toward destination subprocess S2400 may occur together. Additionally, the determine workpiece placement subprocess S2500 may occur along with these subprocesses S2300, S2400. Other, different simultaneous combinations, orderings, etc., may be performed as appropriate.

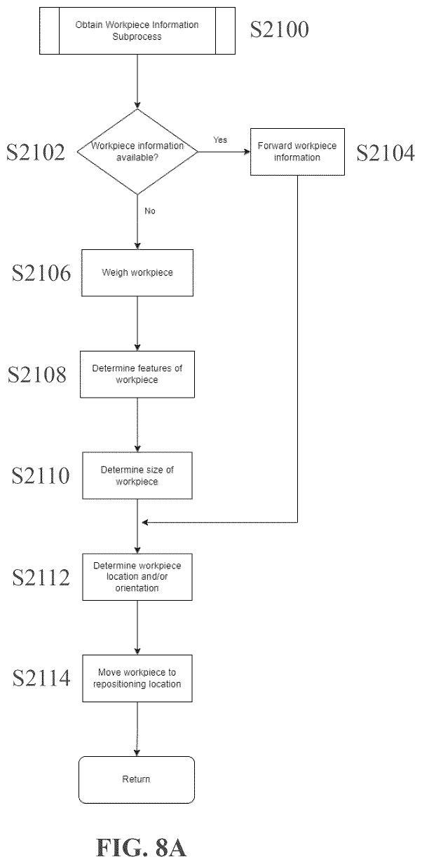

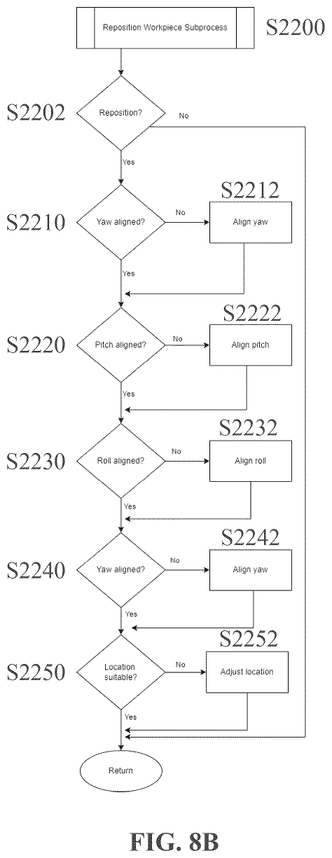

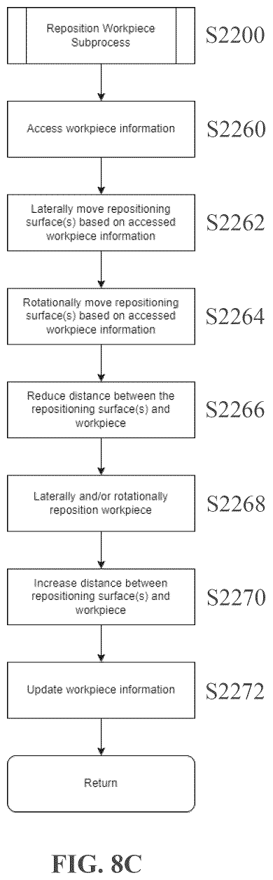

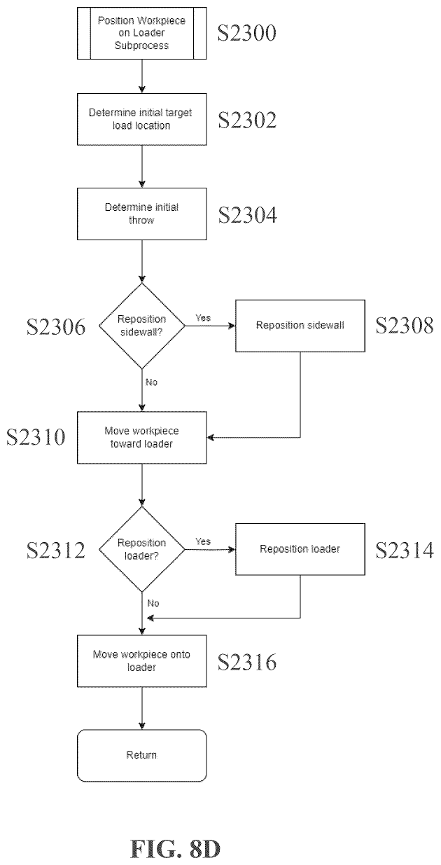

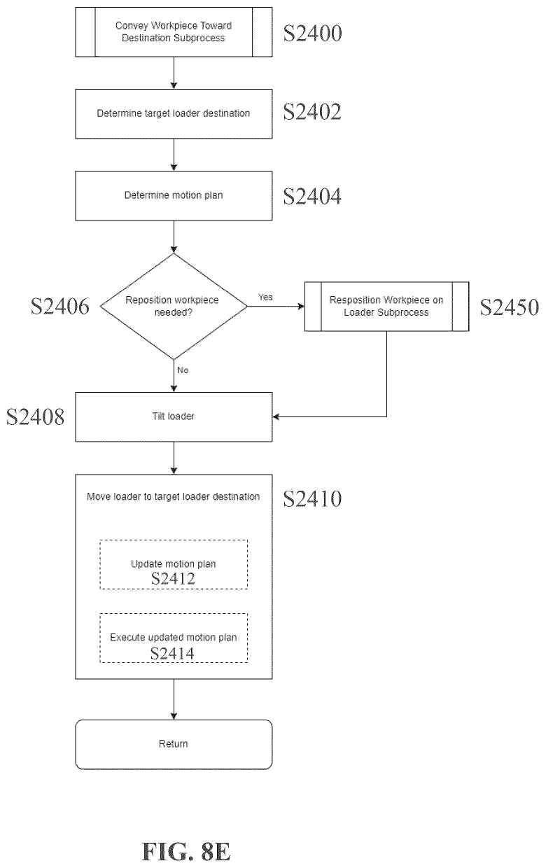

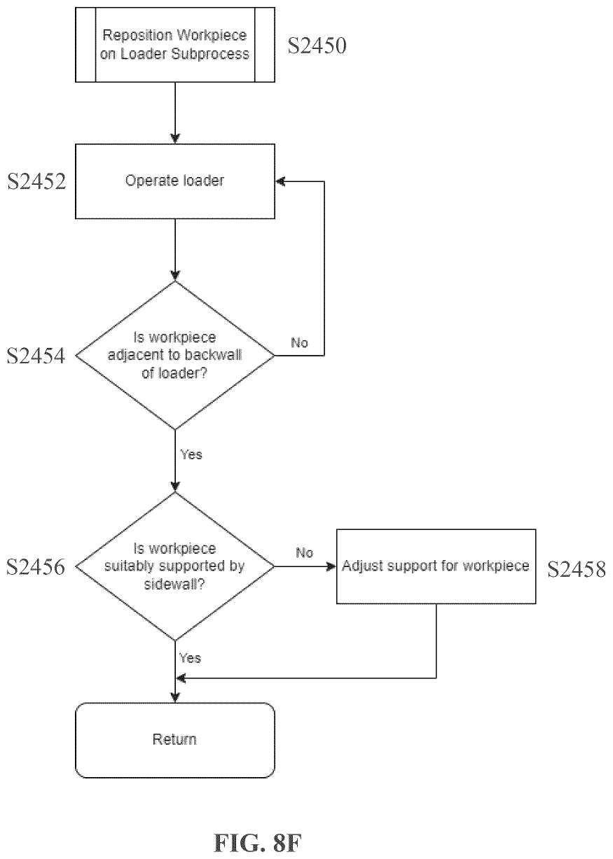

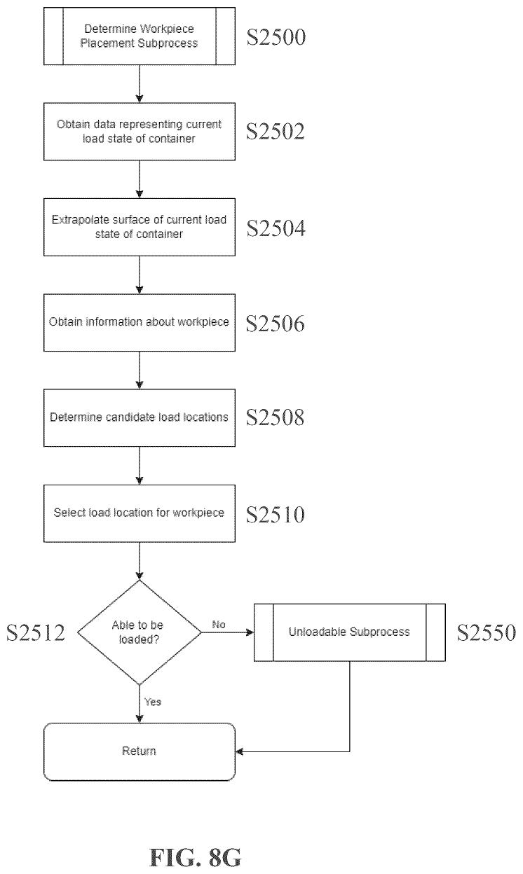

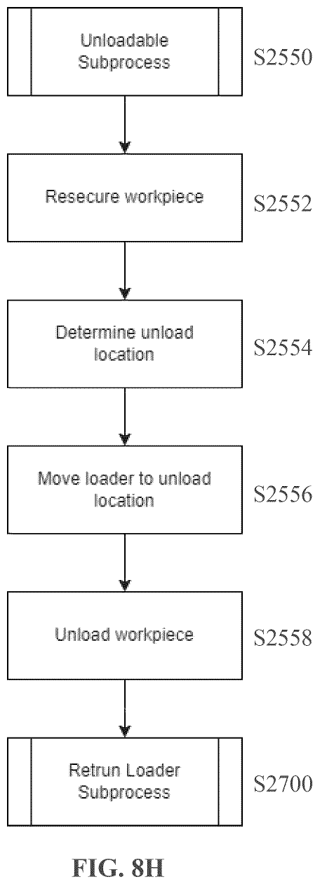

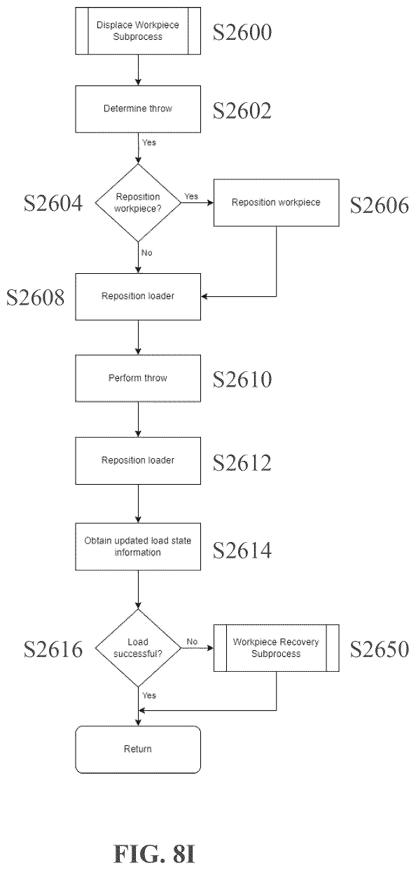

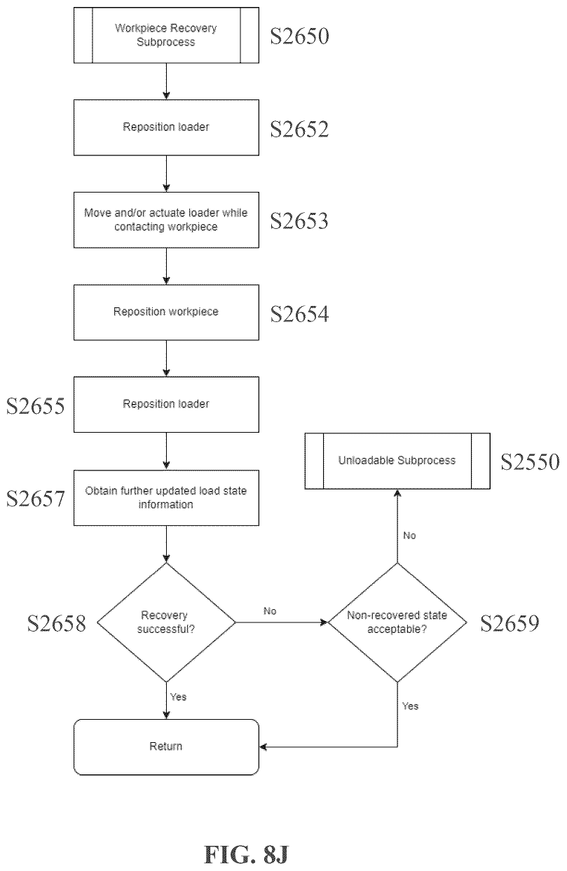

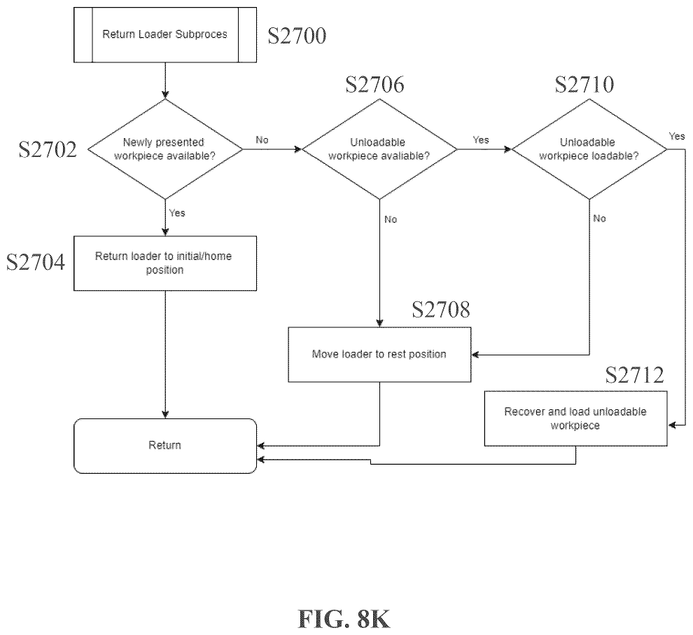

An embodiment of the obtain workpiece information subprocess S2100 is described in reference to FIG. 8A. The obtain workpiece information subprocess S2100 may be configured to permit the system to obtain object information (also referred to as workpiece information) of an object (e.g., target object, workpiece, etc.) to be loaded. The obtain workpiece information subprocess S2100 may include a step of determining whether workpiece information is available S2102. For instance, the workpiece information may have been previously determined either in a prior step or by some other system or means. For example, a system for obtaining workpiece information may be in place to determine and store the workpiece information prior to the workpiece W being temporarily stored within the unloading unit 108. Alternatively, the workpiece information may be obtained while the workpiece W is being transferred by the transportation unit 106. As another example, the workpiece information may be included in a master list, for instance if only a single or a limited number of workpieces are to be loaded.

The workpiece information may include information about one or more aspects of the workpiece W. The workpiece information may include, for example, object parameter information indicative of inherent features of the workpiece/object. Inherent features refer to features of the object that are not altered or changed by movement and positioning of the object. For instance, the object parameter information may include the weight and dimensions of the workpiece or object. The object parameter information may also include more detailed features of the workpiece. For example, the detailed features may include information about the hardness of the workpiece, the material from which the workpiece is partially or fully made, accessories attached to the workpiece, unique components (e.g., handles, straps, wheels, etc.) of the workpiece, etc. Workpiece information may further include situational information about the object that may change according to movement and positioning. Such situational information may include, for example, an orientation (e.g., pitch, roll, yaw) of the workpiece. The situational information may include a location of the workpiece, e.g., a location or position within the structure (e.g., unloading unit 108, transportation unit 106, etc.) in which it is disposed. Other workpiece or object information may be included as needed and based on the type of workpiece to be loaded.

If it is determined that the workpiece information is available in step S2102, the workpiece information may be obtained (e.g., accessed from data storage) and/or forwarded to a processor and/or stored in memory (e.g., as step S2104). This information may then be used at a later time in the obtain workpiece information subprocess S2100. The obtained workpiece information may include information on only a single workpiece, or may include information of a set or batch of workpieces. If the workpiece information is not available, the obtain workpiece information subprocess S2100 may attempt to obtain such information. For instance, various sensors may be used to determine the desired workpiece information. For example, the workpiece W may be weighed (step S2106) to determine the weight of the workpiece W. The workpiece W may also have its features determined (step S2108). Various sensors may be used for determining these detailed features. For example, (2D/3D) cameras, scanners, laser sensors, etc., may be used to obtain image(s) and/or other data about the workpiece. This information may then be passed to a processor for detecting and determining one or more feature of the workpiece.

The obtain workpiece information subprocess may also include a step of determining the workpiece's dimensions (step S2110). The workpiece's dimensions can include one or more of a length, width, depth, diameter, etc. The dimension(s) of the workpiece may be determined using various sensors, such as (2D/3D) camera, scanners, etc.

The obtain workpiece information subprocess may also include a step of determining the workpiece's location and/or orientation information (step S2112). This information may be in absolute or relative terms. For instance, as an embodiment of the information being in relative terms, the location and/or orientation of the workpiece can be determined relative to the task location 114. More specifically, the location and/or orientation information of the workpiece can be relative to a staging area or a conveyor of the task location 114. The location information can describe the 2D or 3D position of the workpiece relative to the staging area or the conveyor of the task location 114. The sensors may also be used to determine the orientation of the workpiece. For instance, the sensors may be used to determine at least one of the pitch, yaw, or roll of the workpiece. This orientation may be relative to a desired orientation of the workpiece and/or relative to the desired orientation on the staging area or the conveyor of the task location. The orientation of the workpiece may be determined using various sensors, such as (2D/3D) camera, scanners, etc.

The obtain workpiece information subprocess may also include the step of moving the workpiece to a repositioning location (step S2114). This may be done by means of a conveyor, a robotic arm, an autonomous vehicle, or any other suitable means. A repositioning location may include, for example, a position on a transfer unit 104 where it may be acted upon by a workpiece repositioner 600.

The order of the steps of the obtain workpiece information subprocess S2100 are not limited to the above-mentioned order. These steps may be performed in any suitable order, combined with other steps, included in other subprocesses, or combined with steps in other subprocesses. For example, the determine features of workpiece step S2108, the determine size of workpiece step S2110, and determine workpiece location and/or orientation step S2112 may occur in any order or may be combined into a single step using, for example, a single instance of obtaining workpiece image data. As another example, these steps may be included in the repositioning workpiece subprocess S2200, an embodiment of which is described below, or included in the step of determining whether repositioning is needed. Further, in some embodiments, some or all of the steps of the obtain workpiece information subprocess S2100 may be omitted. For example, it may not be necessary to determine features of the workpiece (step S2108).

In embodiments, the workpiece loading process 2000 may include a reposition workpiece subprocess, an embodiment of which is shown as the reposition workpiece subprocess S2200 of FIG. 8B. The reposition workpiece subprocess S2200 may be configured to reposition an object or workpiece prior to receipt of the object or workpiece at an object loader. In embodiments, the object or workpiece may be repositioned by the workpiece repositioner 600 while in the transfer unit 104 prior to receipt by the object loader 500/700. The reposition workpiece subprocess S2200 may include the step of determining whether the workpiece should be repositioned (step S2202). If it is determined that no repositioning is needed, the workpiece loading process 2000 may continue without repositioning the workpiece. However, if it is determined that the workpiece should be repositioned, the reposition workpiece subprocess S2200 may continue to cause the workpiece to be repositioned. This repositioning determination may be made based on the object information (either or both of the situational information and/or the object parameter information) obtained in the obtain workpiece information subprocess S2100 and/or previously obtained information. Alternatively or in addition, the repositioning determination may be made based on real time processing of sensor data (e.g., as collected by a 2D/3D camera, associated with the object loader 500, the workpiece repositioner 600, and/or with the overall system 100) representing the workpiece or based on determining the workpiece information at the time just before or during determining whether to reposition the workpiece. The workpiece information may be compared to a threshold orientation requirement, e.g., a requirement that the orientation be within 1%, 5%, or 10% of an angular threshold along each of the three rotational axes (pitch, roll, yaw). Similarly, each of the alignment and realignment steps S2210-S2242 as discussed below that require an alignment determination may be based on a comparison between workpiece information obtained as described above and the appropriate angular threshold. Each alignment determination step may require a reacquisition of workpiece information prior to making the determination. In embodiments, workpiece information may be continuously or repeatedly monitored and/or updated during orientation and/or location adjustment.

The reposition workpiece subprocess S2200 may include the step of determining whether the yaw of the workpiece is aligned (step S2210). If it is determined that the yaw is not correctly aligned, the reposition workpiece subprocess S2200 may provide instructions for aligning the yaw (step S2212). In one embodiment, the workpiece may not have its yaw suitably aligned if the workpiece is not aligned with the task location 114. For example, the workpiece may have its length direction not aligned within a certain angular threshold (e.g., within 10%, within 5%, within 1%) of a moving direction of a conveyor of the task location 114. As an example of the yaw alignment, a processor may determine how the workpiece should be yaw aligned and process instructions for causing the yaw alignment to occur. The repositioning gantry of the workpiece repositioner may operate to move the workpiece about a yaw axis of the workpiece. Alternatively, the repositioning gantry may move the workpiece in a yaw direction without moving along only a single axis. In embodiments, the task location 114 may be the transfer unit 104 and the conveyor may be the repositioner conveyor 620. In embodiments, yaw alignment may be performed by the workpiece repositioner 600, using the repositioning surfaces 630 in conjunction with the various actuators associated therewith.

The reposition workpiece subprocess S2200 may include the step of determining whether the pitch of the workpiece is aligned (step S2220). If it is determined that the pitch is not correctly aligned, the reposition workpiece subprocess S2200 may provide instructions for aligning the pitch (S2222). As an example of pitch misalignment, the workpiece may not be suitably aligned with the task location 114. For example, the workpiece may have its length direction not within a certain angular threshold (e.g., within 10%, within 5%, within 1%) of a direction parallel to the moving direction of the conveyor of the task location. As an example of the pitch alignment, a processor may determine that the workpiece should have its pitched aligned, and process instructions for causing the pitch alignment to occur. For example, a processor can process and send instructions to the repositioning gantry. The repositioning gantry may move the workpiece about a pitch axis of the workpiece. Alternatively, the repositioning gantry may move the workpiece in the pitch direction without moving along a single axis. In embodiments, the task location 114 may be the transfer unit 104 and the conveyor may be the repositioner conveyor 620. In embodiments, pitch alignment may be performed by the workpiece repositioner 600, using the repositioning surfaces 630 in conjunction with the various actuators associated therewith.

The reposition workpiece subprocess S2200 may include the step of determining whether the roll of the workpiece is aligned (step S2230). If it is determined that the roll is not correctly aligned, the reposition workpiece subprocess S2200 may provide instructions for aligning the roll (step S2232). As an example of roll misalignment, the workpiece may not be suitably aligned with the task location 114. For example, the workpiece may have a normal vector of a bottom surface that is not within a certain angular threshold (e.g., within 10%, within 5%, within 1%) of intersecting a surface plane of the conveyor of the task location. As an example of the roll alignment, a processor may determine that the workpiece should have its roll aligned, and process instructions for causing the roll alignment to occur. For example, a processor can process and send instructions to the repositioning gantry. The repositioning gantry may move the workpiece about a roll axis of the workpiece. Alternatively, the repositioning gantry may move the workpiece in a roll direction without moving along a single axis. In embodiments, the task location 114 may be the transfer unit 104 and the conveyor may be the repositioner conveyor 620. In embodiments, roll alignment may be performed by the workpiece repositioner 600, using the repositioning surfaces 630 in conjunction with the various actuators associated therewith.

The reposition workpiece subprocess S2200 may include the step of determining whether the yaw of the workpiece has become misaligned (step S2240, similar to step S2210), for instance due to issues caused by the pitch and/or roll alignment. If it is determined that the yaw is not correctly alighted, the repositioning subprocess S2200 may provide instructions for aligning the yaw (S2242). The yaw alignment S2242 may proceed in a similar fashion as the previously described yaw alignment S2212.

The repositioning workpiece subprocess S2200 may include the step of determining whether the location of the workpiece is suitable (S2250). If it is determined that the location is not suitable, the repositioning workpiece subprocess S2200 may provide instructions for adjusting the location (step S2252) of the workpiece. As an example of an unsuitable location, the workpiece may not be located in a correct location with respect to the task location 114. For example, a center point of the workpiece may not be located withing a threshold of a center of the conveyor of the task location in a widthwise direction of the conveyor. As another example, a side edge of the workpiece may not be within a threshold of a side edge of the conveyor. As an example of the location adjustment, a processor may determine that the workpiece should have its location adjusted, and process instructions for causing the location adjustment to occur. For example, the processor can process and send instructions to the repositioning gantry. The repositioning gantry may adjust the workpiece's location relative to the conveyor of the task area. In embodiments, the task location 114 may be the transfer unit 104 and the conveyor may be the repositioner conveyor 620. In embodiments, object location adjustment may be performed by the workpiece repositioner 600, using the repositioning surfaces 630 in conjunction with the various actuators associated therewith.

The order of the steps of the reposition workpiece subprocess S2200 are not limited to the above-mentioned order. These steps may be performed in any suitable order, combined with another step, included in other subprocesses, or combined with steps in other subprocesses. For example, both the location and yaw of the workpiece may be adjusted in a single step. Further, in some embodiments, some or all of the steps of the reposition workpiece subprocess S2200 may be omitted or repeated as necessary. For example, it may not be necessary to determine and/or align the pitch and roll of the workpiece (steps S2220-S2232).

FIG. 8C depicts another embodiment of the reposition workpiece subprocess S2200. In embodiments, the reposition workpiece subprocess S2200 may include the step of accessing workpiece information S2260. For example, this workpiece information may have been obtained in the obtain workpiece information subprocess S2100 and/or accessed from a memory of the system. In some embodiments, less than all of the workpiece information is accessed during the access workpiece information S2260 step. For instance, only the location and orientation of the workpiece may be accessed. As another example, the size of the work piece can also be obtained. Reducing the amount of information to be accessed during the access workpiece information S2260 step may assist with improving the performance and reduce the processing power needed. As yet another embodiment, the workpiece information may be obtained by a camera, for example attached to the repositioner or attached to a camera mount positioned before the workpiece in the direction of the workpiece moving toward the loader.

In embodiments, the reposition workpiece subprocess S2200 may include the step of laterally moving repositioning surface(s) based on the accessed workpiece information S2262. In some embodiments, laterally moving repositioning surface(s) is based on the accessed workpiece information S2262 step and assists the system with moving the repositioning surface(s) of the repositioner, e.g., the repositioning surface(s) 630 of the workpiece repositioner 600, to better engage the workpiece. For example, by moving the repositioning surface(s) of the repositioner, the risk of damaging the workpiece may be reduced. In some embodiments, the repositioning surface(s) of the repositioner may laterally move the repositioning surface(s) such that a reference point, e.g., a center point between two repositioning surfaces, is located at or near a determined location of the workpiece (e.g., determined in step S2112). The repositioning surface(s) may be moved by one or more motor, such as the linear gantry actuator 640 of the workpiece repositioner 600.

In embodiments, the repositioning workpiece subprocess S2200 may include the step of rotationally moving the repositioning surface(s) based on accessed workpiece information S2264. In some embodiments, this step can assist with better aligning the workpiece for loading onto the loader while reducing potential damage to the workpiece during repositioning. In various embodiments, the accessed workpiece information may be the orientation of the workpiece (e.g., as determined in step S2112). Based on the accessed information, the system may cause one or more repositioning surface of the repositioner (e.g., the repositioning surface(s) 630 of the workpiece repositioner 600) to be rotated. For instance, the repositioning surface(s) can be rotated to correspond to the orientation of the workpiece. The repositioning surfaces(s) may be rotated by a rotational motor, such as by the rotational actuator of the workpiece repositioner 600.

In embodiments, the repositioning workpiece subprocess S2200 may include the step of reducing the distance between the repositioning surface(s) and workpiece S2266, e.g., based on accessed workpiece information. In some embodiments, this step may assist with ensuring a better grip on the workpiece and/or reducing the possibility of damaging the workpiece during repositioning and/or increasing the possibility of a successful repositioning. In various embodiments, the step of reducing the distance between the repositioning surface(s) and the workpiece S2266 may be accomplished by moving either the workpiece or the repositioning surface(s). For example, one or more repositioning surface may be moved by a linear motor to move repositioning surface(s) closer to the workpiece. For example, the linear actuator 660 of the workpiece repositioner 600 may be used to move one or both of the repositioning surfaces. In determining to what extent to move the repositioning surface(s), the system may take various factors into consideration. For example, if only a single repositioning surface is used, the system may move the repositioning surface to be located at a predefined position. If two repositioning surfaces are used, the distance between the two surfaces may be reduce until the surfaces are located near or touch the workpiece. Determining the distance to move the surfaces may be based on various types of data, such as proximity data, image data, etc.

In embodiments, the repositioning subprocess S2200 may include the step of laterally and/or rotationally repositioning the workpiece S2268. In some embodiments, this step may be used for better aligning the workpiece for loading onto the object loader 500 and/or better loading the workpiece within the container. In various embodiments, the step of laterally and/or rotationally repositioning the workpiece S2268 may be accomplished by laterally and/or rotationally moving the repositioning surface(s). For example, the linear and/or rotational motors may be moved to laterally/rotationally move the repositioning surface(s). For instance, the workpiece repositioning surface(s) 630 of the workpiece repositioner 600 may be moved by any combination of the gantry actuator 640, the rotational actuator 650, and/or the linear actuator 660. The relative linear/rotational orientation of the repositioning surface(s) after movement thereof may be predetermined. For example, the repositioning surface(s) may be moved such that a reference plane coplanar with the repositioning surface(s) is aligned in a certain predetermined orientation. As another example, a reference line passing between, parallel with, and along a direction of workpiece travel is aligned in a certain direction.

In embodiments, the reposition workpiece subprocess S2200 may include the step of increasing a distance between the repositioning surface(s) and the workpiece S2270. In some embodiments, this step may be used to allow the workpiece to more freely travel after being repositioned. In some embodiments, this step may be used for reducing the possibility that the workpiece becomes misaligned after having been repositioned. In some embodiments, similar to above-described step S2266, the step of increasing a distance between the repositioning surface(s) and workpiece S2270 step may be accomplished by actuating a linear motor to move the repositioning surface(s) away from the workpiece.

In embodiments, the repositioning workpiece subprocess S2200 may include the step of updating workpiece information S2272. In some embodiments, this step can be used to ensure the system has a more accurate account of the current information of the workpiece. For instance, the workpiece information that is updated may include the location and/or orientation of the workpiece. This workpiece information may be updated with pre-determined information, for instance if the system is configured to locate and align a workpiece to a specific location/orientation. As another example, the workpiece information may be updated based on sensed data (e.g., imaging data) concerning the repositioned workpiece, for instance based on image data.

It should be noted that the various steps of the above-described reposition workpiece subprocess S2200 may be combined, omitted, or rearranged as desired. For example, laterally and rotationally moving the repositioning surface(s) may occur simultaneously. As another example, the laterally and/or rotationally repositioning the workpiece may occur simultaneously with reducing the distance between the repositioning surface(s) and workpiece. As a further example, the increasing distance between the repositioning surface(s) and workpiece step may not be performed. This may occur, for example, when the distance between the workpiece and repositioning surface(s) is sufficiently large to allow the workpiece to freely bypass the repositioning surface(s) after the workpiece has been repositioned.

An embodiment of a position workpiece on loader subprocess S2300 is described in reference to the embodiment of the position workpiece on loader subprocess S2300 of FIG. 8D. The subprocess S2300 may be performed to transfer the workpiece or target object from the transfer unit 104 (or other suitable location) to an object loader, e.g., the object loader 500/700. Although various steps of the position workpiece on loader subprocess S2300 may be performed in any suitable order, inclusive of some steps being optional or omitted, the subprocess may obtain various positioning information indicative of how the workpiece W, which may have been repositioned via the previously described subprocess, is to be moved toward and/or placed into the container. For example, if the obtained positioning information is indicative of how the workpiece W is to be moved toward the container, the positioning information may include various features (both object parameters and situational information) of the workpiece W. For instance, the positioning information may include information concerning any of the location, orientation, weight, center of mass, delicacy, etc. The positioning information may additionally or alternatively include information concerning features of the movement, for example any of speed, acceleration, path, collision avoidance, confidence, etc. Such positioning information may be obtained e.g., by accessing data storage and/or may be obtained during the positioning subprocess by the use of sensors such as 2D/3D cameras, weight sensors, etc.

Positioning information may be indicative of how the workpiece W is to be placed within the container (e.g., target load location) and may include obtained information indicative of the current state of container. Container state information may be obtained, e.g., by one or more imaging devices such as 2D and 3D cameras. From such a state, the system may determine an initial target load location S2302. As an example, based on obtained 2D and/or 3D data indicative of the current state of the container (e.g., any of the position, orientation, weight, delicacy, etc. of object(s) within the container), the system may determine a suitable location, orientation, pose, etc. of the workpiece W. The determine initial target load location S2302 step may also take into consideration various features of object(s) already placed within the container, such as top surface topology, delicacy, etc. The determine initial target load location S2302 may be at least partially replaced by a determine workpiece placement subprocess S2500 or delayed until a determine workpiece placement subprocess S2500 is completed. Accordingly, additional embodiments may be further realized upon review of the later described determine workpiece placement subprocess S2500.

In embodiments, the positioning information of how the workpiece W is to be placed within the container may additionally/alternatively be indicative of a direction in which the workpiece W is to be loaded into the container. For example, an embodiment of the position workpiece on loader subprocess S2300 may include the step of determining an initial throw S2304. As used herein, the term “throw” refers to a manner in which a workpiece is to be transferred off of the object loader 500, e.g., into the container. Various embodiments of different ways in which the workpiece W can be thrown are described below in greater detail. In the determine initial throw S2304 step, various throw information may be taken into consideration. For example, a target load location, e.g., the results of the determine initial target load location S2302 step may be a parameter that is taken into consideration when determining the initial throw information. The throw information may include information describing the direction and manner in which the object or workpiece is to be released from the object loader. This may be of especial importance in certain situations, such as when the size of the opening of a container is restricted and/or the current state of the container indicates that the container is reaching full capacity. In such situations, the loader may be subjected to restrictions as to movement into and/or within the container. Other consideration may include object information concerning the workpiece W (e.g., weight, delicacy, surface friction, rigidity, etc.). Various alternatives and/or additional considerations and processes for determining throw, as well as various aspects of the throw information, which may be partially or entirely applicable here, are discussed further below.

In embodiments, the position workpiece on loader subprocess may include the step of determining whether to reposition a sidewall of the loader S2306. The previously described loader swiper system 530 is an embodiment of a sidewall of the loader. Various information may be taken into account when determining where to position the sidewall of the loader. For example, the information may include the throw information resulting from the determine initial throw S2304 step. More specifically, depending on the type and/or direction of throw specified by the throw information, the sidewall of the loader may be positioned to facilitate such a throw. For instance, if it has initially been determined that the workpiece is to be thrown in a leftward direction, the sidewall may be positioned on the right-side of the workpiece W. As another example, the information may include the object information about the workpiece W. For instance, the information may concern the size, shape, delicacy, etc. of the workpiece W. As yet another example, the information may be based on the location of the workpiece W relative to a transfer conveyor, e.g., the repositioner conveyor 620.

If it is determined that the sidewall of the loader should be repositioned (S2306:Yes), the system may perform the reposition sidewall S2308 step. This may be accomplished, for example, by providing instructions to cause the sidewall of the loader to be repositioned, for instance by actuating the previously disclosed swiper actuator 534 operationally connected to the swiper arm 532. In repositioning the sidewall of the loader in step S2308, the sidewall may be optionally positioned toward a first side of the loader or a second side of the loader opposite to the first side. Alternatively, the sidewall of the loader may be positioned at any position between the first and second sides, as is determined to be appropriate by the system.

Embodiments of the position workpiece on loader subprocess S2300 may also include the step of moving the workpiece toward the loader S2310. For example, the workpiece W may be moved to an end edge of a conveying system, so as to be positioned for loading onto the loader. For instance, the repositioner conveyor 620 of the previously described workpiece repositioner 600 may be used to move the workpiece W to the end edge of the repositioner conveyor 620. As an alternative example, an additional conveying system may be positioned after the repositioner conveyor 620 of the repositioner 600 in the movement direction of the workpiece W toward the loader. The additional conveying system may be operated to move the workpiece toward an end edge thereof.

Embodiments of the position workpiece on loader subprocess S2300 may also include the step of determining whether the loader should be repositioned S2312. It may be determined that the loader should be repositioned to accomplish any number of benefits. For example, the loader may be repositioned to facilitate transfer of the workpiece from the conveying system used to move the workpiece to the loader. It may additionally or alternatively be decided that the loader should be repositioned to facilitate securing the workpiece on the loader. It may additionally or alternatively be decided that the loader should be repositioned based on the initial target load location or the initial throw determination. It may additionally or alternatively be decided that the loader should be repositioned based on information about the workpiece itself (e.g., fragility, weight, detected features, etc.). As can be appreciated from the above-described considerations, one will realize that the data used for making the repositioning determination (in step S2312) may come from a variety of different sources, such as the system's memory system, cameras, sensors, etc. If it is determined that the loader should be repositioned (S2312:Yes), the system will cause the loader to be appropriately repositioned in step S2314.

In embodiments, the system may be designed such that the determining whether the loader should be repositioned S2312 step is unnecessary. For example, the initial or home position of the loader may be deemed to be a suitable position for loading the workpiece onto the loader. For instance, the initial/home position may be such that a top surface of the loader is positioned in essentially the same plane as the top surface of the conveying system used to move the workpiece toward the loader, and may be positioned such that an edge of the loader is adjacent to the end edge of the conveying system. In such a situation, the system may be designed to avoid the inclusion of the step of determining whether the loader should be repositioned S2312. It may be determined that the loader will always be in a suitable position when the workpiece is moved toward the loader or just before the workpiece is to be loaded onto the loader, thereby rendering the repositioning determination unnecessary.

As previously discussed, not all embodiments include every step of the workpiece loading process 2000. In embodiments, at least a portion of the reposition workpiece subprocess S2200 may be omitted. Omitting this step may raise issues may be addressed at other steps that occur later in the process. For instance, if the workpiece is not repositioned in the reposition workpiece subprocess S2200, it still may be desirable to have the workpiece be appropriately positioned on the loader and/or to position the workpiece such that it can be adequately loaded into the container. In some embodiments, this may be accomplished by repositioning the loader for loading the workpiece thereon. As an example, the system may determine (e.g., based on camera or other sensor data) a pose or orientation of the workpiece as it is being moved toward the loader (e.g., during step S2310). Based on this imaging data, the system may determine the relative location of the workpiece on the conveying system moving the workpiece toward the loader and may determine the skew angle of the workpiece about the yaw axis. Based on the determined location and/or skew angle, the loader may be repositioned to accommodate or match the non-ideal position of the workpiece on the conveying system. For instance, if the workpiece is positioned within the middle of the conveying system but has a skew angle of 45 degrees, the loader can be positioned toward the middle of the conveying system but relatively rotated at a 45 degree skew angle so as to receive the workpiece. Upon moving the workpiece onto the loader, the repositioned loader can facilitate proper alignment on the top surface of and support by the loader. In other examples, other rotational alignment or locational positioning aspects may be corrected either during transfer of the workpiece or object onto the object loader (e.g., through positioning of the object loader) or after receipt of the workpiece or object onto the object loader (e.g., through action of the swiper arm system 530 of the object loader 500).

An embodiment of the positioning workpiece on loader subprocess S2300 may include the step of moving the workpiece onto the loader S2316. This may be accomplished in any number of ways. For instance, the workpiece may be pushed or slid onto the loader by using a pusher to move the workpiece. As another example, the conveying system used to convey the workpiece toward the loader (e.g., the repositioner conveyor 620) may also be used to move the workpiece onto the loader. More specifically, the conveying system may be used to slide the workpiece over a top surface of the loader so as to be positioned on the loader. As a further example, the conveying system and a conveyor of the loader may work in tandem to move the workpiece from the conveying system to the conveyor of the loader. More specifically, the conveying system and the conveyor of the loader may be operated at or near the same speed such that the workpiece is transferred onto the loader. The amount, length of time, or strength of pushing, conveying, or joint conveying may be determined based on various factors. For example, one of the factors may be the friction coefficient of the workpiece and/or at least one of the conveyors or surfaces of the loader. For instance, if the workpiece is to be pushed onto the loader, the force by which it is pushed may be based on the relative friction between the workpiece and the surface of the conveyor system and/or surface of the loader. Another example of a factor may be at least one physical dimension, such as length, of the workpiece. If the workpiece is to be pushed, the pushing length may be adjusted such that an end of the workpiece is positioned at or near a certain position, such as the back wall, of the loader. If the workpiece is to be (jointly) conveyed, the length of time that the conveyor(s) are run may be adjusted based on the length of the workpiece such that an end of the workpiece is position at or near the certain position. In some situation, it may be deemed appropriate to position the workpiece on the loader such that less than an entire surface of the workpiece is directly supported by the loader. For example, the workpiece may be moved onto the loader such that a portion of the workpiece is hanging off the side of the loader.

In embodiments, during the move workpiece onto loader S2316 step, the loader may be moved/repositioned as the workpiece is being moved on the loader. In addition to movement/repositioning, the loader may also actuate one or more component thereon to facilitate accomplishment of the intended purpose. In embodiments, the synchronous movement may be useful in assisting with improving the orientation/pose of the workpiece on the loader. For instance, the synchronous movement/actuation may be used to rotate the workpiece in a certain direction. As an example, a distal end of the loader may be positioned toward a middle (in the vertical direction) or top third of the workpiece and while contacting the workpiece. While the workpiece is being pushed or conveyed toward the loader, the loader may be moved toward the workpiece so as to change the relative movement force vector onto the workpiece from the horizontal direction to a diagonal direction. This may cause the workpiece to be flipped onto its adjacent major surface, e.g., rotating the workpiece 90 degrees along the pitch direction. As another example, the loader may be positioned below a plane including the top surface of the conveying system used to move the workpiece toward the loader. As the workpiece is being conveyed onto the lower positioned loader, the workpiece may be flipped onto its adjacent major surface, thereby rotating the workpiece 90 degrees along the pitch direction. This flipping may be facilitated by additionally moving the loader toward a direction opposite to the direction in which the workpiece is being conveyed and/or actuating a conveyor of the loader to move in such opposite direction. Upon being flipped 90 degrees in the pitch direction, the workpiece may be rotated another 90 degrees in the pitch direction. In some embodiments, this may be accomplished by moving the loader or moving the conveyor of the loader in a direction opposite to the direction in which the workpiece was conveyed toward the loader. Flipping the workpiece such that is positioned 90 or 180 degrees in the pitch direction from how it was positioned on the conveying system may facilitate appropriately securing the workpiece on the loader or facilitate or improve loading the workpiece into the container.

FIG. 8E illustrates an embodiment of the convey workpiece toward destination subprocess S2400 of the workpiece loading process 2000. In embodiments, the convey workpiece toward destination subprocess S2400 may cause the workpiece positioned on top of the loader to be moved toward a destination at or near the container. Although the steps of the convey workpiece toward destination subprocess S2400 may occur in various orders, an embodiment may begin with the step of determine target loader destination S2402. In determining the target loader destination, the system may take various factors into consideration. For example, the target loader destination may be based on the target load location. For instance, if the workpiece is to be placed near a top of a container, the loader may be positioned near an upper portion of an opening of the container. The target loader destination may additionally or alternatively be based on other factors, such as avoiding an obstacle near the container. In other embodiments the target loader destination may be predetermined.

In some embodiments, the convey workpiece toward destination subprocess S2400 may include the step of determining a motion plan S2404. The motion plan may correspond to a planned movement of the loader through physical space and may include a series of motion plan parameters, including at least speed, trajectory, and pose or orientation of an end effector. The motion plan may include a planned rotation and/or tilting (e.g., changes in pose or orientation) of the end effector, such as the object loader 500. The motion plan may have the target loader destination be the endpoint. The motion plan may take various considerations into account. For example, the motion plan trajectory may include avoiding obstacles within the movement path of the object loader. The motion plan trajectory may also take into consideration avoidance of other parts of a robotic arm contacting obstacles. The motion plan trajectory may also take into consideration movement of a robotic base relative to the ground. The motion plan parameters may also take into consideration the timing and/or speed of movement. For example, the time required for moving the workpiece from a position near the conveying system to the target loader destination may be minimized by selecting an appropriate motion plan. The speed at which the loader is moved may also be set within the motion plan. The speed may be increased to ensure efficiency or may be decreased to minimize the chance that the workpiece will be dropped during conveyance toward the target loader destination. The speed may also be adjusted based on various features of the workpiece, such as the fragility, center of mass, etc. The speed may also be adjusted based on a confidence parameter, such as how certain the system is that the workpiece is properly supported by the loader.

In embodiments, the convey workpiece toward destination subprocess S2400 may include the step of determining whether to reposition the workpiece S2406. This determination may be based on one or more factors of repositioning information. Repositioning information may include, for example, determined information indicating whether the loader is adequately supporting the workpiece. Repositioning information may further include determined information indicating whether the workpiece is appropriately aligned with the sidewall and/or backwall of the loader. The repositioning information may be based on one or more source of data. For example, the determination of whether the workpiece should be repositioned S2406 step may be based on image data of the workpiece on the object loader and/or sensor data from the loader. For instance, image data may be captured from a camera positioned above the object loader and/or above the top surface of the conveying system used to move the workpiece toward the loader. Alternatively, the image data may be from a camera positioned on the loader itself. As another example of the source of data, a proximity sensor may be positioned within a part of the loader to determine how near the workpiece is to the proximity sensor. For instance, if the proximity sensor is located in a back wall or the sidewall of the loader, the proximity sensor can provide data that corresponds to the proximity of the workpiece to the back wall or sidewall of the loader. If the workpiece is not near enough to the back wall or the sidewall, the system can determine that repositioning of the workpiece on the loader is needed. If it is determined that the workpiece needs to be repositioned (S2406:Yes), the system may perform a reposition workpiece on loader subprocess S2450, an embodiment of which is described in greater detail below.

Some embodiments of the convey workpiece toward destination subprocess S2400 may also include the step of tilting the object loader S2408. Tilting may occur about one or more axis and may be performed to achieve a specific orientation or pose of the object loader. Tilting the object loader may have the benefit of allowing for faster movement of the object loader toward the target loader destination. More specifically, by tilting the object loader, there is a reduced chance that the workpiece will fall off the object loader while the loader is moving. For example, if the object loader is arranged in a neutral orientation (e.g., the loader conveyor is parallel to the ground), directional changes of the object loader during movement may cause the workpiece to shift around laterally (e.g., in the horizontal dimensions) due to momentum because the workpiece is supported against gravity by only the conveyor surface. The object loader may be tilted away from neutral in a first direction such that the workpiece is supported against gravity by two surfaces, e.g., the conveyor surface and either the back wall or the sidewall. In such an orientation, the back wall or sidewall may form a “V” shape in which the workpiece can rest. In this orientation, the cradle created by the arms of the V shape will prevent or reduce the workpiece from shifting on the object loader in at least one horizontal dimension. The object loader may further be tilted away from neutral in a second direction such that the workpiece is supported against gravity by three surfaces, e.g., the conveyor surface, the back wall, and the sidewall. In this orientation, these three surfaces create an inverted hollow pyramid shape. When the workpiece rests inside the inverted hollow, the sides of the inverted hollow will prevent or reduce the workpiece from shifting on the object loader. Thus, tilting the object loader may help ensure a sufficient support of the workpiece by the object loader. The amount and direction of tilting the loader during the tilt loader S2408 step may be predetermined or may be based on one or more factor. For example, a factor taken into consideration may be information about the workpiece, for instance its surface friction and/or its center of mass, etc., and/or the friction of a supporting surface. Another factor may be the speed at which the object loader is to be moved, for instance as laid out by the determined motion plan. Another factor may be the positioning of the workpiece on the object loader. For example, if image or proximity data indicates that the workpiece is not aligned with a sidewall and/or back wall of the object loader, the object loader may be tilted at a greater angle to cause the workpiece to slide along the top surface of the object loader toward the sidewall and/or back wall. This can help ensure that the workpiece is adequately supported by the side and/or back wall of the loader during movement of the loader toward the target loader destination. As still another example, the object loader may be tilted an amount depending on the side on which the sidewall of the object loader is located and the required movement of the loader. For instance, the object loader may not need to be tilted (or tilted by a smaller degree) if the sidewall is supporting the workpiece on the left side rather than on the right side in a situation where the object loader is being moved from left to right. In such a circumstance, the momentum of the workpiece will tend to push the workpiece back against the sidewall because the sidewall is “behind” the workpiece relative to the movement direction of the object loader. If the sidewall is to the right side of the workpiece when the object loader is moved from left to right, there is no support “behind” the workpiece horizontally if the object loader is not tilted. Tilting the object loader in this situation would therefore cause the loader conveyor portion of the object loader to act as a backstop for the workpiece to the horizontal movement of the object loader. If tilting the object loader to a greater extent is used for alignment of the workpiece, the tilt angle of the object loader may be reduced to ensure that the loader is not too tilted while it is moving toward the target loader destination.

Some embodiments of the convey workpiece toward destination subprocess S2400 may include the step of moving the loader to the target loader destination S2410. The loader may move in the tilted or non-tilted state. In some embodiments the loader moves in the tilted state, which has the benefit of allowing the loader to move at a faster speed, as discussed above, and with a reduced chance of dropping the workpiece. In moving the loader to the target loader destination S2410, the loader may be caused to move along the determined motion plan.

In embodiments, the move loader to target loader destination may include the steps of updating the motion plan S2412 and executing the updated motion plan S2414. These steps may be performed if the system determines that it would not be suitable to continue executing the previously determined motion plan. For example, the system may detect that a collision has happened or will likely happen while the loader is in the process of moving to the target loader destination. In such a case, the motion plan may be updated S2412 and executed S2414 to avoid or bypass the collision. As another example, the system may determine that the workpiece is no longer adequately supported by the object loader. For instance, the workpiece may have shifted on the object loader while the object loader is moving to the target loader destination. The motion plan may be updated S2412 and executed S2414 to cause the workpiece to be repositioned, to prevent additional shifting of the workpiece, or to minimize the issues caused by the workpiece having been shifted.

FIG. 8F illustrates an embodiment of the reposition workpiece on loader subprocess S2450. In embodiments, the workpiece may be repositioned on the loader by operating at least one component of the loader in step S2452. For example, if it is determined that the workpiece needs to be repositioned nearer or further away from the backwall of the loader (e.g., based on proximity and/or imaging data), the loader may be operated to move the workpiece toward the backwall. For example, the loader may be tilted along a pitch axis to cause the workpiece to slide toward the back wall. As another example, the loader may have a conveyor that can be operated to cause the workpiece to move toward a backwall of the loader. The system may further perform the step of determining whether the workpiece is adjacent to the backwall of the loader in step S2454. This may be determined based on various data, such as the previously mentioned proximity data or the previously mentioned image data. If the workpiece is determined to be adjacent to the backwall of the loader (S2454:Yes), the system may determine if the workpiece is suitably supported by the sidewall of the loader in step S2456. This determination may also be made based on various data, such as proximity data and/or image data. If the workpiece is determined to not be suitably supported by the sidewall (S2456:No), the system may adjust support for the workpiece in step S2458. In some embodiments, the support for the workpiece may be adjusted by operating the sidewall of the loader. For example, the sidewall of the loader may be moved to become adjacent to the workpiece. As another example, the loader may be tilted about a roll axis by a sufficient enough degree to cause the workpiece to slide toward the sidewall of the loader. By performing at least some of the above steps, the system can improve the position of the workpiece on the loader to allow for greater movement speed of the loader and to reduce the chances that the workpiece will be dropped during movement of the loader.

FIG. 8G depicts an embodiment of the determine workpiece placement subprocess S2500. It should be noted that the steps of this subprocess may be performed in any suitable order and not all steps may be necessary. It should further be noted that this subprocess may be performed at another point within the workpiece loading process 2000 and/or simultaneously with any other process in the workpiece loading process 2000. For example, the determine workpiece placement subprocess S2500 may be performed during the position workpiece on loader subprocess S2300, for instance by replacing the determine initial target load location S2302 step. As another example, the determine workpiece placement subprocess S2500 may be performed after a prior workpiece is displaced from the loader and placed in the container. As yet another example, the determine workpiece placement subprocess S2500 may be performed in parallel to the subprocess of returning the loader to a home or initial position. In embodiments, this step may not be performed every cycle of loading a workpiece into the container.

In embodiments, the determine workpiece placement subprocess S2500 may include the step of obtaining data representing the current load state of the container S2502, e.g., container state information. The container state information representing the current load state of the container may be from one or more sources. For instance, the data may be image data from one or more camera. For example, the data can be 2D image data representing a front view of the container. Additionally or alternatively, the data can be 3D image data representing a front view of the container. Additionally or alternatively, the data can be 2D and/or 3D image data representing a top view of the container taken from either within or outside of the container. Additionally or alternatively, the data may correspond to 2D or 3D representations of workpieces and/or the container (e.g., a digital twin). The data may also represent object information about the already loaded workpieces. For example, the object information about the already loaded workpieces may include, for example, the physical dimensions of one or more workpiece, the fragility parameter of the workpiece, the current compression amount of the workpiece, the weight of the workpiece, the physical features of the workpiece, the off- and/or on-loading priority of the workpiece, etc. In some embodiments image data may be obtained from a vision system positioned on the loader. The loader may be positioned in a position and orientation that allows the vision system to obtain an image of the current load state of the container. For example, the loader may be positioned toward a front of an opening of the container. The vision system may be positioned toward a top or above the container with the vision system's field of view being angled down toward the opening of the container. This can allow the vision system to simultaneously obtain image data concerning the height load state of the container and the top surface load state of the container. In some embodiments, image data may be obtained by a vision system positioned away from the object loader, either on another robotic system or stationarily positioned to provide a view of the container suitable for generating container state information.

In embodiments, the container state information representing the current load state of the container is not obtained every cycle. That is, the system is capable of determining the current load state of the container based on a previously obtained image and/or based on information about previously loaded items.

In embodiments, the determine workpiece placement subprocess S2500 may include the step of extrapolating the surface of the current load state of the container S2504. Although any and all surfaces of the current load state of the container may be extrapolated, for the purposes of this discussion, only an embodiment of the extrapolation of the top surface will be discussed in greater detail. In an embodiment, the top surface of the current load state of the container may be extrapolated from the 2D data representing the front view of the container. For example, the system may generally know (e.g., prestored in memory) information about the container, such as its internal dimensions. Using such information as a reference point, the system may determine the relative location of the previously placed items within the container, including the length, width, and depth of at least a part of the items, e.g., based on the image data. Accordingly, the system may extrapolate the top surface of the current load state of the container based on the determined size and shape of the previously placed items, e.g., based on obtained image data. In another example, the system may extrapolate the surface of the current load state of the container based on a record keeping of the location, pose, and orientation of previously placed items within the container. For instance, a 3D model (e.g., a digital twin) may be generated to represent the stack structure of the previously placed items. From the 3D model, the system may extrapolate a surface (e.g., a top surface) of the current load state within the container. In another example, the system may extrapolate the top surface of the current load state of the container based on a combination of image and record keeping data, either using one set of data to confirm extrapolations based on the other or using both sets of data simultaneously to extrapolate the top surface.

In embodiments, the determine workpiece placement subprocess S2500 may include the step of obtaining information (e.g., object information) about the workpiece S2506 that is to be placed within the container. This information may be obtained from any of a number of different sources. For example, the object information about the workpiece to be placed may be accessed from a database containing known information about the workpiece. For example, the object information may include the physical dimensions of that workpiece. Based on the physical dimensions of the workpiece, the system my assign a weight to the workpiece, knowing that the workpiece is likely to be within a certain range of weights. Alternatively, the object information about the workpiece may be retrieved from the system's memory. For example, if the obtain workpiece information subprocess S2100 was performed, some or all of this object information may be accessed from the system's memory. As another example, the object information about the workpiece may be obtained or verified when the workpiece or object is on the object loader. For instance, a vision system on the object loader or off the object loader may be used to obtain image data from which the object information may be determined. The loader may additionally or alternatively include one or more force-torque sensors. Data from these sensors may be used to determine the weight, center of mass, etc. of the workpiece.

In embodiments, the determine workpiece placement subprocess S2500 may include the step of determining one or more candidate load locations S2508. In the determine candidate load location S2508 step, the system may determine one or more suitable location within the container at which the workpiece may be placed. Each of the determined candidate load locations may provide suitable locations for the current workpiece to be placed, based on any combination of a variety of factors, as discussed below. For example, the system may base the determination on at least the 2D and/or 3D image data representing the front of the container. Utilizing the 2D information, the system may to determine at which height the workpiece may be placed. Determining the candidate load location S2508 step may additionally or alternatively be based on the extrapolated surface of the load state of the container, e.g., as obtained at S2502. This information may be used to determine where in the depth and width direction of the container the workpiece may be placed. For example, the system may determine if there is sufficient space within a portion of the container in which to place the workpiece. As another example, the system may determine if there would be sufficient support from the previously placed workpieces based on the surface contour determined from the extrapolated surface of the load state of the container. Another example of a parameter that the system may take into consideration when determining candidate load locations S2508 is information about the workpiece that is to be placed. For example, the system may determine whether the physical dimensions of the workpiece allow for placing the workpiece at a certain location. Yet another example of a parameter that the system may take into consideration when determining candidate load locations S2508 is information about the previously placed workpieces. As previously mentioned, this information may be based on current or recent sensor information (e.g., image data) or by keeping a record of one or more information about the previously placed workpiece(s). For instance, the location of previously placed workpieces may be (temporarily) stored. This stored data may represent at least the top surface of the current stack structure of the previously placed workpieces within the container. Additionally or alternatively, the location of each previously placed workpiece may be stored as a 3D model (e.g., a digital twin). Other information about the previously placed workpieces may also be stored and utilized for determining candidate load locations S2508. For example, information about any of the workpiece's rigidity, fragility, compressibility, weight, physical features, surface friction, etc. may also be taken into consideration. For example, a workpiece may be assigned a fragility parameter that can be used when determining an appropriate load location. As another example, the weight of the workpiece may be included as a parameter about the workpiece to determine an appropriate load location.

In embodiments, the determine workpiece placement subprocess S2500 may include the step of selecting a load location S2510. This step may be used to select which of the determined candidate load locations (e.g., as determined in step S2508) is the most suitable location for placing the workpiece within the container. Alternatively, in embodiments the determine candidate load location S2508 may not be present and the select load location for workpiece S2510 may be performed without determining candidate load location(s). In embodiments of selecting a load location for the workpiece S2510, the system may take various parameters into consideration. For instance, the system may take into consideration the extrapolated or sensed top surface of the current load state of the container into consideration. For example, the system may use this parameter to prioritize placing workpieces in either the sides or back of the container. The system may also use this parameter to ensure that the one or more portion of the stack structure does not become too high relative to the other areas, thereby reducing the possibility of a portion of the stack structure toppling over. Another example of a parameter that the system may take into consideration when selecting the load location for the workpiece S2510 is one or more information about previously placed workpieces. For example, the system may take into consideration the fragility of previously placed workpieces. The system may ensure that the total weight of items, including the to be placed workpiece, will not exceed a threshold determined based on the fragility of the underlying previously placed item(s). As another example, the system may take into consideration the weight of the workpiece to be placed and the rigidity of the one or more underlying previously placed item. This may help ensure that the underlying items have enough structural rigidity to support what is placed on top of it. The weight of the previously placed items may be taken into consideration to help ensure an appropriate center of mass. The load location for the workpiece may be selected to encourage the center of mass of the loaded container to be toward the middle of the container and toward the bottom of the container. This may help improve the stability of transporting the container from one location to another. Another example of a parameter the system may take into consideration is the ability of the loader to reach certain areas within the container. For instance, the structure of the system may make it difficult for the loader to reach a bottom corner of the container. Accordingly, an item with an appropriate physical dimension may have its load location be selected to be within such a corner. Another example parameter the system may take into consideration is the throwability, e.g., the directions and distances of potential throws of the workpiece into the container by the object loader. This may allow the system to select load locations based on the ability of the item to successfully be placed in the intended location. Further parameters taken into account during load location selection may include object information and/or candidate load location of subsequent workpieces (e.g., the next one to five workpieces) to be placed. In embodiments, the system may identify subsequent workpieces to be placed after the current workpiece. Some aspects of the workpiece loading process 2000 may be performed on the subsequent workpieces simultaneously to those being performed on the current workpiece. For example, obtaining workpiece information (S2100), determining initial target load location (S2302), determining initial throw (S2304), determine candidate load locations (S2508), and/or other relevant steps may be performed for subsequent workpieces. In selecting a load location for a current workpiece from among candidate load locations, the system may account for potential candidate loading locations for subsequent workpieces. For example, if a subsequent workpiece is especially large, the system may select a load location that ensure a large enough space to place the subsequent workpiece remains. In embodiments, the system may select several (e.g., two to five) load locations for subsequent workpieces in advance to obtain improved packing density.

In embodiments, the determine workpiece placement subprocess S2500 may include the step of determining whether the workpiece is able to be loaded S2512. In some circumstances, the system may be unable to determine candidate load locations (step S2508) and/or may be unable to select a load location for the workpiece (step S2510). This may be the result of the system being unable to find a suitable location within the container that can accommodate the physical dimensions of the workpiece or the system determining that none of the candidate locations would adequately support the workpiece or could cause damage to the underlying previously placed items. As another example, the current item to be placed within the container may have a fragility parameter that is below a threshold based on the relative height of the stack of items within the container. If the system determines that the workpiece is unable to be loaded (S2512:No), the system may proceed to the unplaceable subprocess S2550.

FIG. 8H illustrates an embodiment of the unplaceable subprocess S2550. This subprocess may be used in various situations, such as when the system determines that the workpiece currently on the loader is unable to be loaded within the container. This may be due to any number of different circumstances. For example, the system may determine that workpiece is not suitably positioned on the loader, for instance having the sidewall being on an incorrect side of the workpiece. Alternatively, the system may determine that the container is full, that the previously placed items would be unable to support the to be placed workpiece, or that the available space within the container cannot accommodate the to be place workpiece. As another example, the system could determine that the loader would be unable to fit within the container with the workpiece placed thereon.

In embodiments, the unplaceable subprocess S2550 may include the step of resecuring the workpiece S2552. This step may be performed if the system has determined or needs to ensure that the workpiece is in an appropriate location on the object loader for transporting to an unload location. For instance, the workpiece may have shifted during movement of the loader from the position near the conveying system to the target loader destination (e.g., the movement of step S2410). As another example, the type of movement for moving the workpiece to the unload location may be determined to require a different type of support for the workpiece than was needed to support the workpiece during the movement from the conveying system to the target loader destination. In performing the resecuring workpiece S2552 step, the system may obtain information about the current positioning of the workpiece on the loader. As previously mentioned, there are various ways in which the system may obtain this information (e.g., proximity sensors, camera data, etc.). Based on the current positioning of the workpiece, the loader (or a portion thereof) may be operated to cause the workpiece to move toward a more desirable location that improves its security and/or support. Alternatively, the step of resecuring the workpiece S2552 may not utilize the step of determining the current location of the workpiece on the loader. Instead, the loader (or a portion thereof) may be operated to attempt to cause the workpiece to move toward the more desirable location regardless of its current location, e.g., through operation of the swiper arm system, loader conveyor, and/or or orientation adjustment.

In embodiments, the unplaceable subprocess S2550 may include the step of determining an unload location S2554. In embodiments, this step may be unneeded, for example if the unload location is predetermined. For example, the unload location may be predetermined to be a certain real world point or a point relative to the base of the robotic arm or relative to the target loader destination. In embodiments, the unload location may be determined using various factors. For example, the system may take into consideration any obstacles that may be within the vicinity of the loader and/or container. The obstacles may be other components, humans, or previously unplaceable items. The presence of an obstacle may be obtained in any suitable fashion, such as analyzing image or sensor data. The destination is not limited to a certain point, but may be more generally defined as an area. In some embodiments, it may be determined that more than one unload location is possible. In such a situation, the system may select the best of the plurality of possible unload conditions. This selection may be based on the presence of and/or information about the previously unplaceable items. The unload location may be determined to improve performance of the system, avoid damage to the to be place workpiece or previously unplaceable workpieces, facilitate future loading or unloading of the container, etc.

In embodiments, the unplaceable subprocess S2550 may include the step of moving the loader to the unload location S2556. Before physically moving the loader, the system, in some embodiments, may first develop a motion plan. The motion plan may correspond to a planned path along which the loader or a portion of the robotic arm is to travel from a location corresponding to the target loader location to the determined unload location. The system may cause the loader to move (e.g., by sending movement signals to a robotic arm) toward the unload location.

In embodiments, the unplaceable subprocess S2550 may include the step of unloading the workpiece S2558. This step may cause the workpiece to be transferred from on the loader to the unload location. This can be accomplished in a number of different ways. For example, the conveyor of the loader can be operated to release or throw the workpiece. Additionally or alternatively, the loader can be moved and/or tilted in various directions to cause the workpiece to be slid off the loader. After the workpiece has been unloaded, the return loader subprocess may be run, an embodiment of which is described later.

FIG. 8I depicts an embodiment of the displace workpiece subprocess S2600. In some embodiments, the displace workpiece subprocess S2600 may be run to cause the workpiece to be placed within the container. This can be accomplished in a number of different ways, and may partially depend on the type/structure of container into which the workpiece is to be placed and/or dependent on the shape/style of loader and/or dependent on the workpiece to be placed.

In embodiments, the displace workpiece subprocess S2600 may include the step of determining the throw S2602. In this step, the system may determine throw parameters indicative of how the workpiece is to be unloaded from the loader. As previously mentioned, it is not necessary that this step be performed at this relative point of the workpiece loading process 2000. Instead, it may be performed ahead of time, such as before or during the position workpiece on loader subprocess S2300. For instance, this step may replace the determine initial throw S2304 step of the position workpiece on loader subprocess S2300. Even if the determine throw S2602 step is performed earlier or replaces former steps, the determine throw S2602 step may be performed again to either confirm that the throw is still applicable or to further refine how the throw is to actually be performed.

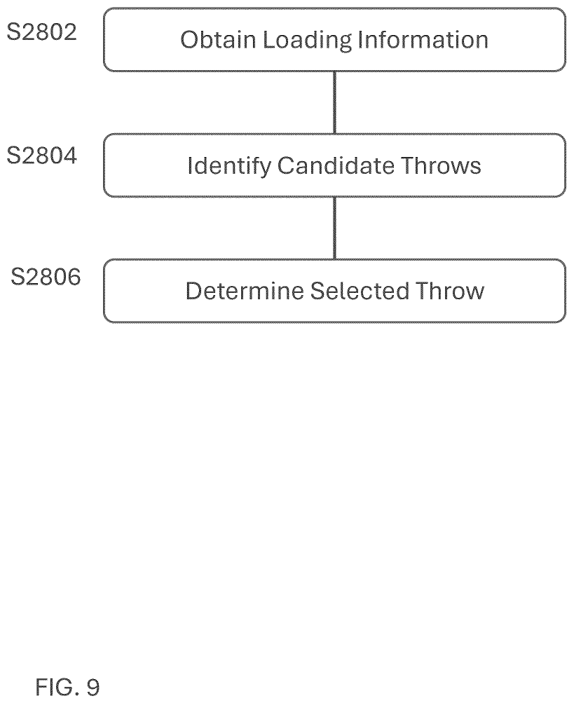

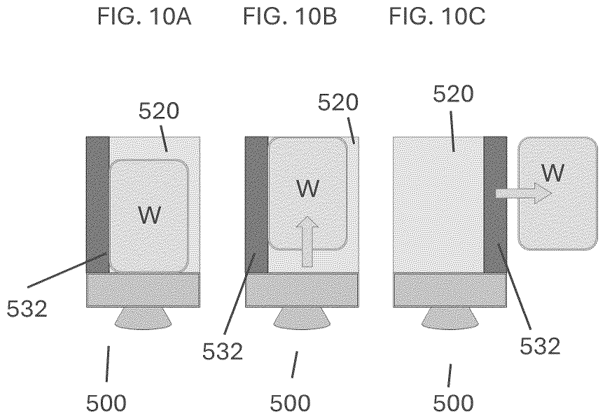

In embodiments of determining the throw S2602, the system may select a throw from a predetermined set of possible throws Further discussion of potential throws is provided below with respect to FIGS. 9-10. In embodiments, the parameters for performing the throw may be calculated based on the determined throw from the set of possible throws or may be newly calculated for each workpiece. In determining the throw S2602, the system may take various considerations into account. For example, the system may take into account the selected load location for the workpiece (e.g., as selected in step S2510). The system may additionally or alternatively take into consideration the possible locations, poses, and orientations that the loader may take near or within the container, either based on an empty container or based on the current load state of the container. The system may additionally or alternatively take into consideration information about the workpiece to be loaded, e.g., object information. For instance, the system may take into consideration the friction and/or weight of the workpiece to be loaded.

In determining the throw S2602, the system may determine various parameters of operating and/or moving the loader in performing the throw. For example, the system may determine how fast to operate the conveyor of the loader. This may ensure that the item is appropriately thrown with enough force that the workpiece travels the necessary distance to reach and be located in the intended load location. Additionally or alternatively an edge of the loader may be tilted by a determined angle to further increase the distance that the workpiece may travel or to clear certain determined obstacles. The system may also determine the speed at which to operate the sidewall of the loader. This may facilitate moving the workpiece off of a side of the loader, which may be helpful when there is insufficient space within the container for the loader to take a more favorable pose. That is, the system may determine that a side throw may be suitable in certain situations. In embodiments, the system may determine that the loader should perform a throw by tilting an edge of the loader downward by a sufficient enough angle that the workpiece can be slid off the surface of the loader. Additionally or alternatively, the loader may be moved in a lateral direction while the workpiece is being conveyed or slid off the loader. This may allow the workpiece to be more gently placed on the stack of previously placed items. In embodiments, the system may determine that the workpiece should be thrown in a diagonal direction. Although a diagonal throw may be performed in a number of different fashions, in one embodiment this may be accomplished by both operating the conveyor and sidewall of the loader. By varying the relative speed of the conveyor and sidewall, the angle of the diagonal throw can be changed. The system may alternatively determine that some combination of the above described movements may be performed to result in the determined throw.

In embodiments, the displace workpiece subprocess S2600 may include the step of determining whether the workpiece is to be repositioned S2604. The system may determine that the workpiece should be repositioned for any of a variety of different reasons. For example, the system may determine that the workpiece has shifted during movement from the conveying system to the target loader destination (e.g., during step S2410). Additionally or alternatively, the system may determine that the workpiece is not adequately supported by the loader for movement into the container. Additionally or alternatively, the system may determine that the workpiece should be repositioned to enhance the throw performance and/or reduce the chance of loading the workpiece being unsuccessful. For example, the system may determine that the workpiece should be aligned with an edge of the loader before performing the throw. As another example, the system may determine that the workpiece should stick out from or overhang an edge of the loader. If the system determines that the workpiece should be repositioned (S2604:Yes), the system may cause the loader to reposition the workpiece during step S2606. For example, the conveyor of the loader may be operated to cause the workpiece to be moved to a different location on top of the loader. Additionally or alternatively, the sidewall of the loader may be operated to shift the workpiece to a different location on top of the loader. Additionally or alternatively, the pose and/or orientation of the loader may be adjusted to cause the workpiece to slide along the surface of the loader to be positioned at another location on top of the loader. In some embodiments, this step may be performed after repositioning the loader or as part of performing the throw.

In embodiments, the displace workpiece subprocess S2600 may include the step of repositioning the loader S2608. Although not always needed, this step may cause the loader to be moved to a more suitable position for unloading the workpiece. In embodiments, this step may be omitted if the target loader destination is sufficient for the system being able to perform an unloading process. When repositioning the loader, the system may determine a suitable location based on the determined type of throw (e.g., as determined in step S2602). The system may also determine the suitable location to minimize potential damage to the workpiece to be placed and/or the previously placed items.

In embodiments, the displace workpiece subprocess S2600 may include the step of preforming the throw S2610. This step may cause the workpiece to exit the loader and be placed within the container. For example, this loader may be operated based on the one or more throw parameter for performing the determined throw (e.g., as determined in step S2602). Depending on the throw to be performed, one or more component of the system may be operated. For instance, only the conveyor or the sidewall of the loader may be operated. Alternatively, both the conveyor and the sidewall may be operated, either in series or in tandem. As another example, the conveyor and/or sidewall may be operated while the loader is being moved. For instance, the conveyor and/or sidewall may be operated to move the workpiece over the front or side edge of the loader while the loader is being move in the opposite direction. Further discussion of throw parameters and the throw operation is provided below with respect FIGS. 9-10.

In embodiments, the displace workpiece subprocess S2600 may include the step of repositioning the loader S2612. This step may be used to place the loader in a better position for obtaining an updated load state of the container. After or during repositioning the loader, the system may perform the step of obtaining information representing the updated load state S2614 of the container. For instance, a camera attached to the loader may be used to obtain image data of the updated load state of the container. More specifically, the camera may take a picture of the current load state of the container after the workpiece has been thrown or displaced to its load location. As another example, the system may operate a sensor or camera positioned separate from the loader to obtain data about the updated load state of the container. In this example, repositioning the loader may be performed to provide a clear line of sight for the separate camera or sensor. For example, 2D and/or 3D image data may be captured of the container from the front. In some embodiments, the 2D and/or 3D data alone or in comparison to prior 2D/3D data may be indicative of a compression state of the items within the container.

In embodiments, the system may perform the obtain updated load state information S2614 step after performing each throw. In embodiments, the system may perform the obtain updated load state information S2614 step less frequently and/or dynamically. For example, the obtain updated load state information S2614 step may be performed after one or two layers of workpieces have been placed within the container. The system may dynamically determine whether to perform the step after one or two layers based on the type of container into which the workpieces are being placed. As another example, the system may determine the frequency of performing the obtain updated load state information S2614 step based on the number of workpieces placed within the container, with the frequency increasing with the more workpieces that have been placed. As another example, the system may increase the frequency with increasing height of the stack of items within the container. The system may adjust the frequency of performing the obtain updated load state information S2614 step based on the type of workpiece being placed within the container. For instance, the system may increase the frequency if the current or former workpiece placed within the container has a rigidity and/or compressibility parameter below a certain threshold, which may increase the likelihood of workpieces shifting. Obtaining updated load state information of the container may be performed based on newly captured image data and/or based on a record of deposited workpieces, as discussed above. In embodiments, load state information may be updated according to the record of placed workpieces and, after several such updates, updated based on newly captured image data as a confirmation that the record of placed workpieces provides an accurate representation of the load state information.

In embodiments, the displace workpiece subprocess S2600 may include the step of determining whether the workpiece was successfully loaded S2616. This step may be used for determining whether the workpiece is correctly positioned at the load location. This step may also be used for determining whether the workpiece has the correct orientation and pose within the container. As another example, the system may determine whether the workpiece is sticking out of the container or has fallen out of the container. In some embodiments, the system may not actually perform a determination of whether the load was successful, or may perform it at a later time. For instance, the system may base subsequent workpiece loading processes based primarily on the updated load state information (e.g., by machine learning). In some embodiments, a determination that the load was unsuccessful (S2616:No) may result in the system performing a workpiece recovery subprocess S2650.

FIG. 8J depicts an embodiment of the workpiece recovery subprocess S2650. It should be noted that the workpiece recovery subprocess S2650 may not be utilized in some embodiments of the workpiece loading process 2000. For instance, the workpiece may be recovered manually. As another example, the system may not attempt to recover the workpiece and instead adjust future cycles based on the knowledge that an item has been misplaced. A misplaced item may simply be in a different place than intended and not a place that prevents or limits future loading.

In embodiments, the workpiece recovery subprocess S2650 may include the step of repositioning the loader S2652. The loader may be repositioned so that a portion of the loader is contacting the workpiece to be recovered. For example, the loader may be positioned so that a distal end of the loader is contacting the workpiece.

In embodiments, the workpiece recovery subprocess 2650 may include the step of moving and/or actuating the loader while contacting the workpiece S2653. This step may be used to move the workpiece back onto the loader or may be used to cause the workpiece to move without being loaded back onto the loader. For example, a conveyor belt of the loader may be operated to pull the workpiece back onto the loader or the loader may scoop up the workpiece from the container. As another example, a portion of the conveyor belt of the loader may be operated to apply a force to the workpiece to cause the workpiece to rotate or be moved in a direction. As yet another example, the loader may be used to physically contact the workpiece to cause the workpiece to be nudged in a direction or to cause it to topple over or to be pressed down toward the previously placed items.

In embodiments, the workpiece recovery subprocess 2650 may include the step of repositioning the workpiece S2654 within the container. This process may not be needed if the workpiece was already repositioned during the move and/or actuate object loader while contacting workpiece step S2653. As an example of when the step of repositioning the workpiece S2654 may be used, the workpiece to be recovered may be positioned on top of the object loader. In such a situation, the object loader may be operated to attempt to reposition the workpiece within the container.

In embodiments, the workpiece recovery subprocess 2650 may include the step of secondary repositioning of the loader S2655. For example, the loader may be moved to a position where an updated load state of the container can be obtained, e.g., by a vision system or camera on or off the object loader. Depending on by what means the updated information is obtained, the object loader may be moved to an appropriate location.

In embodiments, the workpiece recovery subprocess 2650 may include the step of obtaining further updated load state information S2657. This step may be used to obtain information as to whether the recovery process was successful. For example, the object loader may be moved so that a vision system attached thereto can obtain information about the load state of the container. As another example, a camera system may be used to obtain 2D and/or 3D image(s) from a front of the container.

In embodiments, the workpiece recovery subprocess 2650 may include the step of determining whether the recovery was successful S2658. For example, the system may determine whether the obtained updated load state information corresponds to what was expected to be the state had the initial load attempt been successful. A successful recovery may be understood as a recovery in which the workpiece is repositioned within the container in the expected manner.

If the recovery is determined to be unsuccessful (S2658:No), the workpiece recovery subprocess S2650 may include the step of determining whether the non-recovered state is acceptable S2659. This step may be used to avoid the situation of the system continuing to attempt to recover the workpiece. If it is determined that the non-recovered state from the recovery attempt is acceptable (S2659:Yes), the system may continue the workpiece loading process 2000 to allow other items to be placed within the container. An acceptable non-recovered state may be a state in which the workpiece has been repositioned in an unexpected manner that does not prevent a successful loading of the container. For example, the workpiece is not positioned as intended during repositioning, but is not sticking out of the container, arranged precariously, or arranged such that it takes up more room than necessary. If it is determined that the non-recovered state is unacceptable (S2659:No), the workpiece may be placed on the loader and the system may perform the unplaceable subprocess S2550.

FIG. 8K depicts an embodiment of the return loader subprocess S2700. It should be noted that the return loader subprocess S2700 may not be necessary in some embodiments of the workpiece loading process 2000. If the return loader subprocess S2700 is to be included, the return loader subprocess S2700 may include the step of determining whether a newly presented workpiece is available S2702. For example, the system may determine if there is another workpiece to be loaded into the container that has not yet gone through the workpiece loading process (e.g., not yet been processed by the workpiece loading process 2000 or has gone through only a part of the workpiece loading process 2000). If such a newly presented workpiece is available (S2702:Yes), the loader may be returned to the initial/home position in step S2704. As previously mentioned, an embodiment of the initial/home position of the loader may be near the conveying system used to move a workpiece toward the loader for loading. In other embodiments, the initial/home position may be another appropriate location. In returning the loader to the initial/home position (step S2704), the system may perform motion planning, for example maximizing efficiency while avoiding obstacles. The system may iterate the workpiece loading process 2000 on the newly presented workpiece, with further iterations continuing until there is no further newly presented workpiece available.

In embodiments, the system may determine that a newly presented workpiece is not available (S2702:No). In embodiments, the lack of a newly presented workpiece may represent that no further workpiece (e.g., a workpiece that has not yet gone through the workpiece loading process 2000) is available. However, in other embodiments, the lack of a newly presented workpiece may represent that even if there is a workpiece that has not yet been processed by the workpiece loading process 2000, there is no available container with sufficient space to accommodate the newly presented workpiece. In either case, the return loader subprocess S2700 may include the step of determining whether an unplaceable workpiece is available S2706.

In some embodiments, the return loader subprocess S2700 may include the step of determining if an unplaceable workpiece is available S2706. An unplaceable workpiece may correspond to an item that was previously determined to not be able to be loaded (e.g., step S2512:No) and/or processed by the unplaceable subprocess (e.g., S2550). As another example, an item placed in an unplaceable workpiece destination may be deemed an unplaceable workpiece. Separately placing an item at an area corresponding to the unplaceable workpiece destination may be useful in certain situations, such as placing items with a higher fragility parameter or a smaller size in such a location for better ensuring that the item will be placed toward the top of the container. This may help reduce the possibility of damaging loaded items and may help ensure a greater fill of the container. If there is no unplaceable workpiece available (S2706:No), the system may cause the loader to move to a rest position S2708. In some embodiments, the rest position of the loader may be position in which the loader is less likely to cause interference with other processes that are to be completed. In some embodiments, the rest position may be a position in which a component capable of moving the loader, e.g., a robotic arm, is in a compacted state and/or a state in which stress on its joints is reduced.

In embodiments, if the system determines that an unplaceable workpiece is available (S2706:Yes), the return loader subprocess S2700 may include the step of determining whether the unplaceable workpiece is loadable S2710. In some embodiments, this step may be used to determine whether circumstances have changed such that a previously determined unplaceable item is now loadable. For example, an item may have been determined to be unplaceable due to it having a lower fragility parameter than was allowed based on the height of the stack of the previously placed items within the container. Once the stack reaches a sufficient height, the previously unplaceable fragile item may be determined to be loadable at a later time. If the system determines that the unplaceable workpiece is loadable (S2710:Yes), the system may inform an operator that the unplaceable workpiece is now available for manual loading. Alternatively, the system may attempt to load the unplaceable item itself. If the system determines that the unplaceable workpiece remains unplaceable (S2710:No), the system may alert an operator that the unplaceable workpiece should be attempted to be manually loaded. Alternatively, the system may proceed to moving the loader to the rest position (e.g., step S2708).

In embodiments, the return loader subprocess S2700 may include the step of recovering and loading the unplaceable workpiece S2712. In various embodiments, this step allows the system to cause the unplaceable item to be recovered from a location, e.g., the unplaceable location, and be placed within a suitable location within the container. In some embodiments, there may be more than one item in the unload location. As a result, the system may be configured to detect which unplaceable item is to be recovered and operate to recover such unplaceable item. For instance, the loader may be moved and/or operated to cause the unplaceable item to be placed thereon. The loader can then be moved to a suitable location for loading the unplaceable workpiece at a selected location within the container. Upon loading the unplaceable item within the container, the loader may be moved to an appropriate location, for instance either the initial/home or rest position.

FIG. 9 is a flow chart illustrating a throw determination subprocess S2800. The throw determination subprocess S2800 may be an example the step of determining the throw S2602 of the displace workpiece subprocess S2600. The throw determination subprocess S2800 may include steps of obtaining a load location S2802, identifying candidate throws S2804, and determining a selected throw S2806.

The throw determination subprocess S2800 may include the step of obtaining the loading information S2802. Loading information may include selected load location (e.g., from step S2510), object information about the workpiece, and container state information.

The throw determination subprocess S2800 may include the step of identifying candidate throws S2804. Candidate throws may be defined by a series of throw parameters. Throw parameters may include, for example, throw type, conveyor movement, swiper movement, object loader position, object loader orientation, object loader movement, travel distance, and others. In embodiments, the system may include a predefined library of throws, each having one or more default parameters. Identifying candidate throws may include selecting one or more throws from the predefined library of throws, selecting and modifying parameters of one or more throws from the predefined library of throws, and/or selecting all of the parameters of a throw from scratch to generate a new throw. The different throw types discussed in FIGS. 10-16 represent different throws, e.g., ways in which a workpiece may be released. In embodiments, a predefined library of throws may include one or more of each type of throw. If more than one throw of a type is stored in the library, each version may have different throw parameters and may be used to obtain different results. Identifying candidate throws may be performed by taking into account parameters and information from the loading information, e.g., the selected load location, object information about the workpiece, and container state information. Thus, candidate throws may be identified based on information about where the workpiece will be placed, the current state of the container, and the workpiece itself.

FIGS. 10-16 illustrate aspects of different throw types and are discussed in greater detail below. As discussed above, a throw may be defined by one or more throw parameters, including at least throw type, conveyor movement, swiper movement, object loader position, object loader orientation, object loader movement, travel distance, and others. Throw type may refer to a type or style of throw, some of which are discussed below with respect to FIGS. 10-16. Conveyor movement may refer to a pattern of movement of a loader conveyor of an object loader performed during a throw and may include movement direction, movement speed, and movement timing. Movement timing may refer to the timing of the load conveyor movement, e.g., during a throw, the load conveyor may change speeds, change directions, and/or start or stop movement according to the movement timing. Swiper movement may refer to a pattern of movement of a swiper arm of an object loader performed during a throw and may include swiper movement direction, swiper movement speed, and swiper movement timing. Swiper movement timing may refer to the timing of the swiper movement, e.g., during a throw, the swiper arm may change speeds, change directions, and/or start or stop movement according to the movement timing. Object loader position may refer to the positioning of the object loader during a throw and may be determined relative to the loading location and/or in absolute terms with respect to the container. Object loader orientation may refer to an orientation or pose of the object loader during a throw, including, for example, the multi-dimensional angle at which the object loader is oriented. Object loader movement may refer to movement of the object loader either before a throw (e.g., when approaching the container) and/or during a throw, including, for example, changes in object loader position and changes in object loader orientation. Object loader movement may include parameters indicative of object loader movement speed and object loader movement timing. Travel distance may refer to a distance, horizontally and/or vertically, that a workpiece or object is expected or intended to travel during a throw. The throw types illustrated in FIGS. 10-16 are by way of example only. Other styles of throw may be achieved through any suitable combination of the above-discussed throw parameters.

FIGS. 10A-10C illustrate aspects of a side release throw. The side release throw is shown with respect to the object loader 500 and may equally be carried out by the object loader 700. FIG. 10A illustrates a position of the workpiece Won the object loader 500 during object loader travel (e.g., the workpiece W is supported by both the back wall and the sidewall). In the side release throw, the workpiece W is advanced to the front of the object loader 500 through action of the loader conveyor 520, as shown in FIG. 10B. In embodiments, the workpiece W may be advanced such that a portion of the workpiece extends off of the object loader 500. The swiper arm 532 is then activated to push the workpiece W off of the loader conveyor 520 and into the container, as shown in FIG. 10C. The side release throw may facilitate packing a container in areas that are obscured by the front wall, e.g., spaces behind the front wall that may be difficult to reach if the object is released in a forward direction from the object loader 500. In embodiments, a speed of the swiper arm 532 and an orientation of the object loader 500 may be altered, e.g., to adjust the distance that a workpiece travels when released from the object loader 500. Although illustrated as a release to the right side of the object loader 500, the swiper arm 532 may be arranged on the opposite side of the workpiece W when the workpiece is loaded onto the object loader 500. This arrangement may permit the workpiece W to be released to the left side of the object loader.

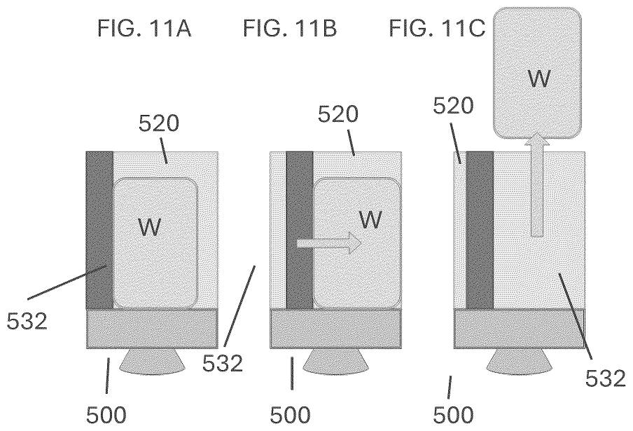

FIGS. 11A-11C illustrate aspects of a front release throw. The front release throw is shown with respect to the object loader 500 and may equally be carried out by the object loader 700. FIG. 11A illustrates a position of the workpiece Won the object loader 500 during object loader travel (e.g., the workpiece W is supported by both the back wall and the sidewall). In the front release throw, the workpiece W is advanced to the side edge of the object loader 500 through action of the swiper arm 532, as shown in FIG. 11B. In embodiments, the workpiece W may be advanced such that a portion of the workpiece extends off of side edge the object loader 500. The loader conveyor 520 is then activated to push the workpiece W off of the loader conveyor 520 and into the container, as shown in FIG. 11C. The front release throw may facilitate packing a container that has a relatively high stack height. A relatively high stack heigh may prevent the object loader 500 from entering into the container for a side release, thus requiring a front release throw. In embodiments, a speed of the loader conveyor 520 and an orientation of the object loader 500 may be altered, e.g., to adjust the distance that a workpiece travels when released from the object loader 500.

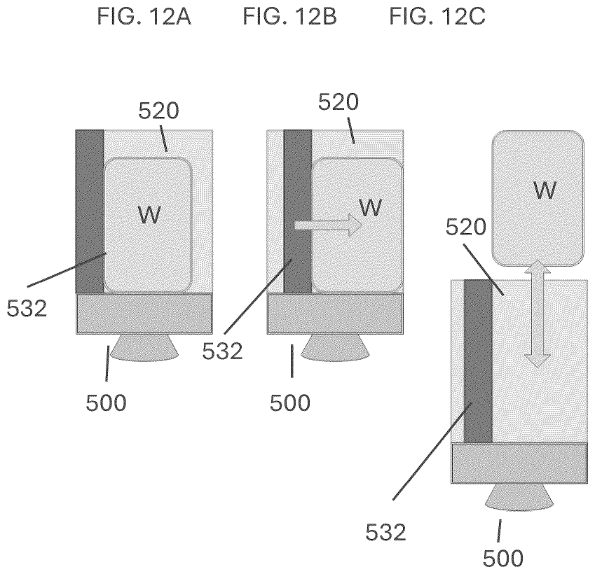

FIGS. 12A-12C illustrate aspects of a front synchronous release throw. The front synchronous release throw is shown with respect to the object loader 500 and may equally be carried out by the object loader 700. FIG. 12A illustrates a position of the workpiece W on the object loader 500 during object loader travel (e.g., the workpiece W is supported by both the back wall and the sidewall). In the front synchronous release throw, the workpiece W is advanced to the side edge of the object loader 500 through action of the swiper arm 532, as shown in FIG. 12B. In embodiments, the workpiece W may be further advanced such that a portion of the workpiece extends off of the front edge of the object loader 500. The loader conveyor 520 is then activated to push the workpiece W off of the loader conveyor 520 and into the container, as shown in FIG. 12C, while, simultaneously or synchronously, the object loader 500 is pulled back in a direction opposite the release direction of the workpiece W. The front synchronous release throw may facilitate a gentler release of the workpiece W. For example, if the object loader 500 is positioned over the loading location, synchronously advancing the workpiece W while pulling the object loader 500 back may result in the workpiece W being laid down into the loading location rather than being thrown. In embodiments, a speed of the loader conveyor 520 and an orientation of the object loader 500 may be altered, e.g., to adjust the distance that a workpiece travels when released from the object loader 500.

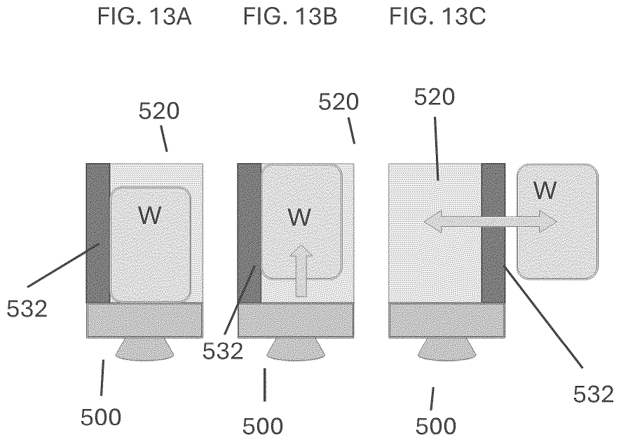

FIGS. 13A-13C illustrate aspects of a side synchronous release throw. The side synchronous release throw is shown with respect to the object loader 500 and may equally be carried out by the object loader 700. FIG. 13A illustrates a position of the workpiece W on the object loader 500 during object loader travel (e.g., the workpiece W is supported by both the back wall and the sidewall). In the side synchronous release throw, the workpiece W is advanced to the front edge of the object loader 500 through action of the loader conveyor 520, as shown in FIG. 13B. In embodiments, the workpiece W may be further advanced such that a portion of the workpiece extends off of the side edge the object loader 500. The swiper arm 532 is then activated to push the workpiece W off of the loader conveyor 520 and into the container, as shown in FIG. 13C, while, simultaneously or synchronously, the object loader 500 is moved sideways in a direction opposite the release direction of the workpiece W. The side synchronous release throw may facilitate a gentler release of the workpiece W. For example, if the object loader 500 is positioned over the loading location, synchronously advancing the workpiece W while moving the object loader 500 away may result in the workpiece W being laid down into the loading location rather than being thrown. In embodiments, a speed of the swiper arm 532 and an orientation of the object loader 500 may be altered, e.g., to adjust the distance that a workpiece travels when released from the object loader 500. Although illustrated as a release to the right side of the object loader 500, the swiper arm 532 may be arranged on the opposite side of the workpiece W when the workpiece is loaded onto the object loader 500. This arrangement may permit the workpiece W to be released to the left side of the object loader.

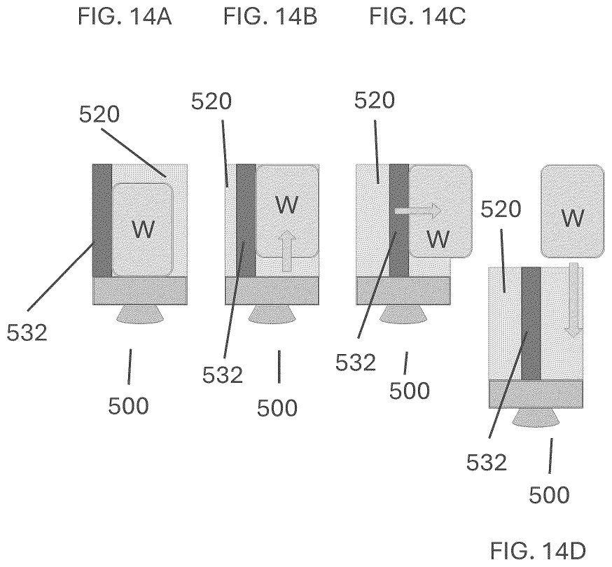

FIGS. 14A-14D illustrate a front side release throw. The front side release throw is shown with respect to the object loader 500 and may equally be carried out by the object loader 700. FIG. 14A illustrates a position of the workpiece Won the object loader 500 during object loader travel (e.g., the workpiece W is supported by both the back wall and the sidewall). In the front side release throw, the workpiece W is advanced to the front edge of the object loader 500 through action of the loader conveyor 520, as shown in FIG. 14B. The workpiece W may be further advanced such that a portion of the workpiece extends off of the side edge the object loader 500, as shown in FIG. 14C. The load conveyor 520 is then activated to push the workpiece W off of the loader conveyor 520 and into the container, as shown in FIG. 14D, while, simultaneously or synchronously, the object loader 500 is moved backwards in a direction opposite the release direction of the workpiece W. The front side release throw may facilitate release of the workpiece W when a loading location for the workpiece W is partially occluded from the front. The front side release throw may advantageously place a workpiece W behind another workpiece in the container stack. In embodiments, a speed of the load conveyor 520 and an orientation of the object loader 500 may be altered, e.g., to adjust the distance that a workpiece travels when released from the object loader 500. Although illustrated as a release to the front and right side of the object loader 500, the swiper arm 532 may be arranged on the opposite side of the workpiece W when the workpiece is loaded onto the object loader 500. This arrangement may permit the workpiece W to be released to the front and left side of the object loader.

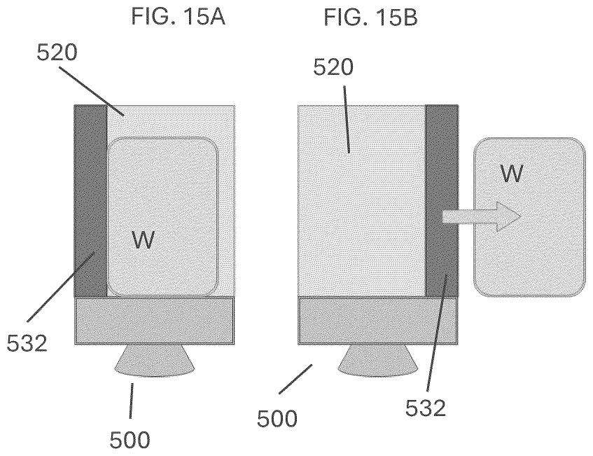

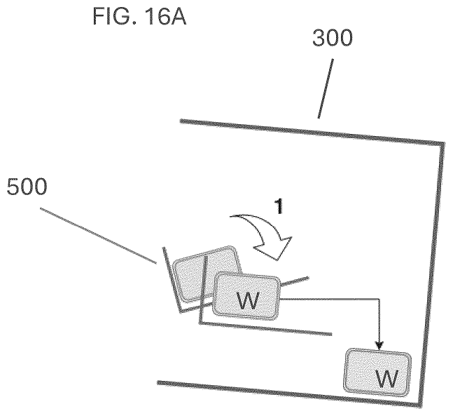

FIGS. 15A-15B illustrate a back side release throw. The back side release throw is shown with respect to the object loader 500 and may equally be carried out by the object loader 700. FIG. 15A illustrates a position of the workpiece W on the object loader 500 during object loader travel (e.g., the workpiece W is supported by both the back wall and the sidewall). In the back side release throw, the workpiece W is advanced to the side edge of the object loader 500 through action of the swiper arm 532 and released off of the side edge, as shown in FIG. 15B. In the side release throw, the workpiece W remains at the back wall during release. Variations of this throw may include object loader movement away from the direction of workpiece release and/or positioning of the workpiece partially over the side edge prior to release. In embodiments, a speed of the swiper arm 532 and an orientation of the object loader 500 may be altered, e.g., to adjust the distance that a workpiece travels when released from the object loader 500. Although illustrated as a release to the right side of the object loader 500, the swiper arm 532 may be arranged on the opposite side of the workpiece W when the workpiece is loaded onto the object loader 500. This arrangement may permit the workpiece W to be released to the left side of the object loader.

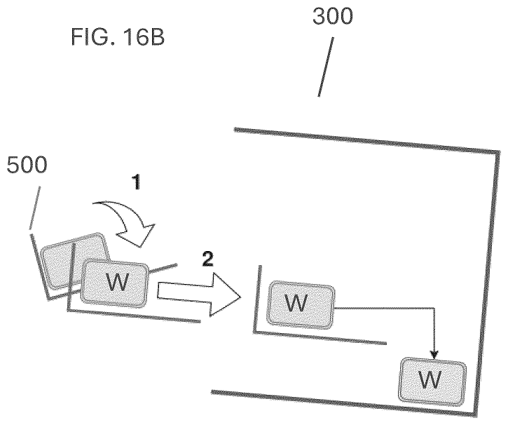

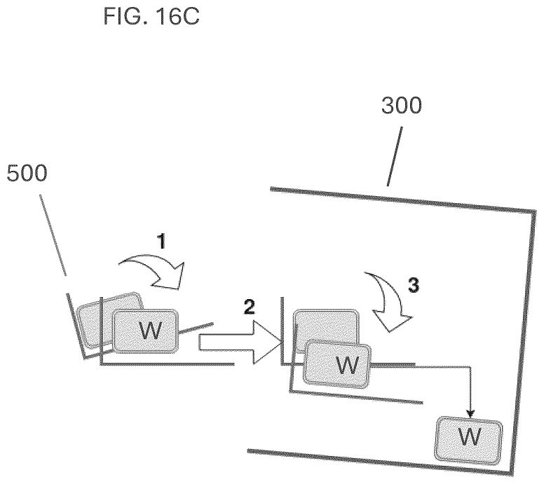

FIGS. 16A-16C illustrate variations in object loader approach to a container. The object loader approach is an example of an object loader movement parameter. FIG. 16A illustrates an object loader approach including alignment of the object loader 500 inside the container 300. As shown in FIG. 16A, a container 300 may be oriented with a tilt during loading. The tilt may assist in the loading process by ensuring that workpieces are biased towards the back of the container. As shown in FIG. 16A, the object loader 500 may approach the container 300 in a tilted orientation that supports the workpiece W during movement. The object loader 500 may then, while inside the container 300, adjust its orientation to align with the orientation of the container 300 prior to releasing the workpiece. By waiting until the container 300 is entered to adjust the orientation of the object loader 500, the system may ensure that, should the orientation adjustment cause the workpiece to potentially fall off the object loader 500, this will occur inside the container 300.

FIG. 16B illustrates an object loader approach including alignment of the object loader 500 outside of the container 300. As shown in FIG. 16B, a container 300 may be oriented with a tilt during loading. As shown in FIG. 16B, the object loader 500 may approach the container 300 in a tilted orientation that supports the workpiece W during movement. The object loader 500 may then, prior to entering the container 300, adjust its orientation to align with the orientation of the container 300. The object loader 500 may then enter the container with the workpiece W, align with the appropriate loading location, and release the workpiece W. Aligning the object loader 500 outside of the container 300 may have the advantage of reducing the profile of the object loader 500 with respect to the opening of the container 300. In the tilted orientation, the object loader 500 has a larger profile at the angle of the container opening. The larger profile takes up more of the opening. By aligning the object loader 500 such that the object loader 500 is substantially (e.g., within 5%) of parallel with the floor of the container 300, the system may reduce the profile of the object loader 500. This, in turn, permits, the object loader 500 to enter into a smaller space. This may be useful, for example, when the container 300 is already partially full and there is less room for the object loader 500 to enter.

FIG. 16C illustrates an object loader approach including partial alignment of the object loader 500 outside and partial alignment inside the container 300. As shown in FIG. 16C, a container may be oriented with a tilt during loading. As shown in FIG. 16C, the object loader 500 may approach the container 300 in a tilted orientation that supports the workpiece W during movement. The object loader 500 may then, while outside the container 300, adjust its orientation to partially align with the orientation of the container 300 prior to releasing the workpiece. The object loader 500 may be adjusted such that it is substantially horizontal (e.g., within 5%). This orientation takes up less of the container profile than the fully tilted orientation, but more than the orientation where the object loader 500 is substantially parallel to the ground of the container 300. After entering the container 300, the object loader 500 may be adjusted such that it is substantially parallel with the ground of the container 300 prior to releasing or throwing the workpiece W. The partial alignment approach may be useful for workpieces W that are likely to slip off of the object loader 500 if it is tilted parallel to the container 300. By partially aligning inside and partially aligning outside, the system may improve the ability of the object loader 500 to enter the container while preventing slippage of the workpiece from the object loader 500 before it enters the container 300.

Returning now to FIG. 9, the throw determination subprocess S2800 may include the step of determining a selected throw S2806. As discussed above, the identify candidate throws step S2804 may be performed to identify one or more candidate throws that will be able to successfully release a workpiece W to the load location. Selection of the throw to be performed, e.g., the throw determined by step S2602 of subprocess S2600, may be performed based on a priority among the candidate throws. Priority among the candidate throws may, for example, be predetermined according to throw type. For example, a front synchronous throw may have a highest priority, followed by a front synchronous variation with the workpiece extending past the edge of the object loader. In another example, a front throw that involves the object travelling a long distance after release (e.g., being thrown from afar), may have a low priority. Priority among candidate throws may be based on additional factors as well, including any combination of throw parameters. In embodiments, the system may determine an expectation of success for the combinations of throw parameters in each identified candidate throw. For example, different throw types may have different levels of success based on travel distance parameters (or any other throw parameter). Larger travel distance parameters (horizontal and/or vertical) may be more likely to result in failure for different types of throws. Thus, priority may be determined according to an identified candidate throw having a highest likelihood of success. In further embodiments, priority among the candidate throws may be determined according to a combination of throw parameters, object information, and/or load location. For example, different throw types or parameters may have a lower or higher likelihood of success depending on object size or loading location. For example, long thin workpieces may be more likely to unexpectedly roll or rotate during a front release throw as compared to a side release throw. In another example, soft-sided workpieces may be more likely to tumble when thrown in certain ways. Such potential for success may be employed when selecting a candidate throw with a highest priority.

In some alternative embodiments, a loader different than the previously described embodiments of loaders may be used. For instance, a loader is not required to have a conveyor. Instead, it could have a smooth surface upon which the workpiece is slid. As another example, the loader may be a claw, vacuum head, or other suitable gripper.

The above Detailed Description of examples of the disclosed technology is not intended to be exhaustive or to limit the disclosed technology to the precise form disclosed above. While specific examples for the disclosed technology are described above for illustrative purposes, various equivalent modifications are possible within the scope of the disclosed technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or sub-combinations. Each of these processes or blocks may be implemented in a variety of different ways. Also, while processes or blocks are at times shown as being performed in series, these processes or blocks may instead be performed or implemented in parallel, or may be performed at different times. Further, any specific numbers noted herein are only examples; alternative implementations may employ differing values or ranges.

These and other changes can be made to the disclosed technology in light of the above Detailed Description. While the Detailed Description describes certain examples of the disclosed technology as well as the best mode contemplated, the disclosed technology can be practiced in many ways, no matter how detailed the above description appears in text. Details of the system may vary considerably in its specific implementation, while still being encompassed by the technology disclosed herein. As noted above, particular terminology used when describing certain features or aspects of the disclosed technology should not be taken to imply that the terminology is being redefined herein to be restricted to any specific characteristics, features, or aspects of the disclosed technology with which that terminology is associated. Accordingly, the invention is not limited, except as by the appended claims. In general, the terms used in the following claims should not be construed to limit the disclosed technology to the specific examples disclosed in the specification, unless the above Detailed Description section explicitly defines such terms.

Although certain aspects of the invention are presented below in certain claim forms, the applicant contemplates the various aspects of the invention in any number of claim forms. Accordingly, the applicant reserves the right to pursue additional claims after filing this application to pursue such additional claim forms, in either this application or in a continuing application.

1. A system for loading an object comprising:
an object loader positioned on a robotic arm, the object loader including a swiper arm configured to provide lateral movement to the object and a conveyor configured to provide longitudinal movement to the object; and
at least one control circuit configured to execute software instructions for:
obtaining object information of the object to be loaded;
positioning the object on the object loader according to the object information;
conveying the object toward an object destination;
determining a target location for the object; and
displacing the object to the target location.

2. The system of claim 1, wherein obtaining object information further comprises:
obtaining object parameter information.

3. The system of claim 2, wherein obtaining the object parameter information includes accessing data storage containing the object parameter information.

4. The system of claim 2, wherein obtaining the object parameter information includes determining object parameter information including one or more of:
object weight,
object features, and
object size.

5. The system of claim 2, wherein obtaining object information further comprises determining either or both of object location and object orientation.

6. The system of claim 1, further comprising:
a transfer unit; and
an object repositioner including a repositioning gantry and a repositioning surface;
wherein the at least one control circuit configured to execute software instructions further includes instructions for:
repositioning by the object repositioner prior to receiving the object at the object loader according to the object information.

7. The system of claim 6, wherein repositioning the object further includes:
identifying a misalignment of one or more of yaw, pitch, and roll;
correcting the misalignment;
identifying a misalignment of location; and
correcting the misalignment.

8. The system of claim 6, wherein repositioning the object further includes:
translating the repositioning surface laterally according to the object information;
reducing a distance between the repositioning surface and the object;
repositioning the object laterally by the repositioning surface;
increasing the distance between the repositioning surface and the object; and
updating the object information according to a repositioned pose of the object.

9. The system of claim 6, wherein repositioning the object further includes:
translating the repositioning surface rotationally according to the object information;
reducing a distance between the repositioning surface and the object;
repositioning the object rotationally by the repositioning surface;
increasing the distance between the repositioning surface and the object; and
updating the object information according to a repositioned pose of the object.

10. The system of claim 1, wherein positioning the object on the object loader includes:
determining an initial target location;
determining an initial throw operation;
positioning the swiper arm to accommodate the initial throw operation; and
receiving the object on the object loader.

11. The system of claim 10, wherein positioning the object on the object loader further includes:
moving the object towards the object loader; and
positioning the object loader to receive the object.

12. The system of claim 1, wherein conveying the object toward the object destination includes:
determining a target destination;
determining a motion plan; and
moving the object loader to the target destination.

13. The system of claim 12, wherein conveying the object toward the object destination includes:
repositioning the object on the object loader.

14. The system of claim 12, wherein conveying the object toward the object destination includes:
tilting the object loader.

15. The system of claim 12, wherein conveying the object toward the object destination includes:
determining an updated motion plan; and
performing the updated motion plan.

16. The system of claim 13, wherein repositioning the object on the object loader includes:
operating the object loader to position the object at a backwall of the object loader; and
operating the object loader to support the object with the swiper arm of the object loader.

17. The system of claim 1, wherein determining the target location for the object includes:
obtaining load state information of a target container;
determining candidate target locations in the target container according to the load state information and the object information; and
selecting the target location from the candidate target locations.

18. The system of claim 1, wherein determining the target location for the object includes:
obtaining load state information of a target container;
determining candidate target locations in the target container according to the load state information and the object information; and
determining that the object cannot be loaded to any of the candidate target locations.

19. The system of claim 18, wherein determining the target location for the object further includes:
determining an unload location as the target location.

20. The system of claim 1, wherein displacing the object to the target location includes:
determining a throw operation; and
performing the throw operation.

21. The system of claim 20, wherein determining the throw operation further includes:
selecting the throw operation from a predetermined set of throws, the predetermined set of throws including side release throws, front release throws, front synchronous release throws, side synchronous release throws, front side release throws, and back side release throws; and
determining parameters of the throw operation according to the object information and load state information at the target location.

22. The system of claim 20, wherein displacing the object to the target location further includes:
repositioning the object on the object loader; and
repositioning the object loader.

23. The system of claim 20, wherein displacing the object to the target location further includes:
obtaining updated load state information;
determining to perform an object recovery according to the load state information; and
performing the object recovery.

24. The system of claim 1, wherein the swiper arm is actuated by a motor and configured to move laterally above the conveyor.

25. The system of claim 24, wherein:
The swiper arm includes a swiper guide, and
the object loader includes a swiper rail configured to interface with the swiper guide to support the swiper arm.

26. The system of claim 1, wherein the robotic arm is configured to tilt the object loader around a longitudinal axis and around a lateral axis.

27. The system of claim 1, wherein the conveyor is a belt conveyor.

28. The system of claim 27, wherein:
the belt conveyor is actuated by a drive motor connected to a rear roller of the belt conveyor via a drive belt, and
the drive motor and rear roller are configured in a vertically stacked arrangement.

29. The system of claim 1, wherein the object loader further includes a sensor system configured to sense one or more of:
a presence of an object on the conveyor,
a location of an object on the conveyor,
a location of the swiper arm.

30. The system of claim 6, wherein:
the transfer unit includes a transfer unit conveyor,
the repositioning gantry is disposed over the transfer unit conveyor,
the repositioning surface is disposed on a repositioning blade, and
the repositioning blade is attached to the repositioning gantry and configured for lateral and/or rotational movement with respect to the transfer unit conveyor.
